(19) United States
(12) Patent Application Publication
(10) Pub. No.: US 2016/0237311 A1
(43) Pub. Date: Aug. 18, 2016

(54) LOW DIELECTRIC CONSTANT, LOW DIELECTRIC DISSIPATION FACTOR COATINGS, FILMS AND ADHESIVES

(71) Applicants: Farhad G. MIZORI, San Diego, CA (US); DESIGNER MOLECULES, INC., San Diego, CA (US)

(72) Inventor: Farhad G. MIZORI, San Diego, CA (US)

(21) Appl. No.: 15/025,260

(22) PCT Filed: Sep. 26, 2014
(86) PCT No.: PCT/US14/57903

§ 371 Date: Mar. 25, 2016

Related U.S. Application Data
(60) Provisional application No. 61/883,130, filed on Sep. 26, 2013.

(51) Int. Cl. C09D 179/08; C08L 79/08; C08L 51/06; C08K 5/5419

(52) U.S. Cl. CPC C09D 179/085; C08K 5/5419; C08L 79/085; C08L 51/06; C08L 2203/202; C08L 2203/204; C08L 2203/206

(57) ABSTRACT

Curable functionalized imide-linked polyimides compounds have been synthesized that have been found to possess very low dielectric constant and extremely low dissipation factor. These compounds also have a range of high to low modulus, extremely low moisture uptake and are very thermally stable. The combination of these materials in formulation along with functionalized polyethylene, polypropylene, polybutadiens have been found to be ideal for forming films and coatings for the microelectronic applications, multiplayer capacitors and interconnects, and high power cables and wire coatings. The addition of perfluorinated hydrocarbons, and POSS nanoparticles to the formulations have decreased the dielectric constant and dielectric dissipation factor further, and have also improved the flammability of the compositions.

### RELATED APPLICATIONS

This application claims benefit of priority of U.S. Provisional Application Ser. No. 61/883,130 filed Sep. 26, 2013, the entire disclosure of which is incorporated herein by reference.

### FIELD OF INVENTION

This invention relates to low dielectric constant and low dielectric dissipation factor polymers, films, adhesives, and electronic parts using the same. In particular, compositions comprising maleimide-terminated polyimide resins, functionalized polyethylene, polypropylene, polybutadienes, along with perfluorinated hydrocarbon fillers and POSS nanoparticles.

### BACKGROUND OF INVENTION

Due to a rapid increase in communication information, there is a strong demand for miniaturization, weight reduction and speed of electronic devices for high-density mounting. The electronics industry has put a greater demand for low dielectric electrically insulating materials and polymers that are adapted for operation in a high frequency environment.

The polymeric materials used in high power devices must satisfy a number of critical thermal, environmental, and electrical requirements to meet the required performance criteria for microelectronics applications. These desired attributes include thermal stability, low moisture uptake, high breakdown voltage (low leakage current), low dielectric constant and low dissipation factor. The use of these polymers allows for advanced electronic packaging techniques, resulting in improved system performance and reliability.

To insure the proper operation of a high power electronic circuit, proper isolation must be assured between adjacent conductors. High voltage arcing and leakage currents are typical problems encountered in high voltage circuits and are exacerbated at high frequencies. To counter these effects, a good dielectric material must display low values for dielectric constant and dissipation factor (loss tangent) and a high value for breakdown voltage.

Dielectric constant is the ratio of the permittivity of a substance to that of free space. A material containing polar components, such as polar chemical bonds, which are presented as electric dipoles has an elevated dielectric constant, in which the electrical dipoles align under an external electric filed. As a result, a capacitor with a dielectric medium of higher k will hold more electric charge at the same applied voltage or, in other words, its capacitance will be higher. The dipole formation is a result of electronic polarization, distortion polarization, or orientation polarization in an alternating electric field. These phenomena have characteristic dependencies on the frequency of the alternating electric field, giving rise to a change in the real and imaginary part of the dielectric constant between the microwave, ultraviolet, and optical frequency range.

The ratio of the energy consumed in a dielectric material per cycle of an alternating electric field to the energy stored therein is known as a dielectric dissipation factor. The dielectric loss of a material is proportional to a relative dielectric constant multiplied by a dielectric dissipation factor. Therefore, in a high frequency region the dissipation factor increases as the frequency increases. Heat release per unit area is increased by high density mounting of electronic devices. In order to reduce the dielectric loss an insulating material with a low dissipation factor must be used. If a low dielectric polymer material having a low dielectric loss is used, then heat release due to dielectric loss and electric resistance is suppressed, resulting in a reduced malfunction of signals. For this reason, a material having a low transmission loss or energy loss is strongly desired in the high frequency communications field.

Many different polymers having good insulating properties and low dielectric constants have been used in electronic applications. The ideal material will have low dielectric constant, low dissipation factor, and good film forming properties, high heat resistance, good adhesion to a variety of substrates, and very low moisture uptake. Other properties that are very important for many applications include low cost of manufacturing, low flammability, good chemical resistance, and low ionics. Thus far there is no material that fulfills all of these great characteristics.

### SUMMARY OF INVENTION

Maleimide functionalized compounds have been known for many decades. Bismaleimides (BMI resins) are considered among the most important, top tier high performance resins. These compounds have been used extensively in electronics, aerospace and other industries that require high temperature reliability.

Bismaleimide resins in the liquid form are very rare: U.S. Pat. No. 7,884,174 B2 Mizori), and U.S. Pat. No. 7,157,587 B2 (Mizori et al), the contents of which are incorporated herein by reference in their entirety, disclose the synthesis of a new class of thermosetting elastomers. The physical properties of these new maleimide-capped polyimide resins range from low melting powders to viscous liquids. These compounds are an ideal class of high performance elastomers due to their observed properties, such as: hydrophobicity, hydrolysis resistance, low melt viscosities (for the solids), the fact that many are liquids at room temperature, the very high temperature resistance, and the low modulus. Many of these compounds can be precipitated in acetone or methanol to give low melting powders that have very good film-forming properties.

Although a great deal of work has been done with the maleimide-terminated polyimides disclosed in U.S. Pat. Nos. 7,884,174 and 7,157,587, they also describe a wide variety of other functional groups that can be found on the terminus position of the polyimide. Certain of these other functional groups can be free-radically cured (e.g., (meth)acrylates, vinyl ethers, vinyl esters, itaconates, citraconimides, vinyl groups and the like). These patents also describe imide-linked polyimides terminated with epoxies, benzoxazines, oxazolines and the like that can also be cured to form very good films and coatings. All of these imide-linked polyimides are contemplated for use in the invention of low dielectric constant, low dielectric dissipation factor adhesives, films and coatings.

Thus, maleimide-terminated polyimides of the invention include, but are not limited to, compounds having the Formulae I-V, show below:

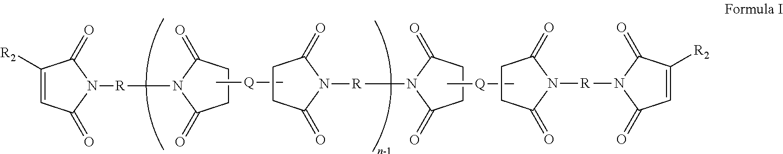

where each of R and Q is independently a substituted or an unsubstituted aliphatic, alkenyl, aromatic, heteroaromatic, or siloxane moiety; R₂ is H or methyl; and n is an integer having the value between 1 and about 10,

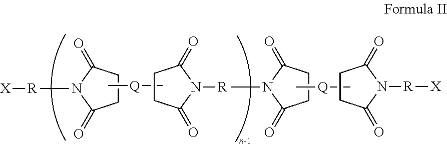

wherein each of R and Q is independently a substituted or an unsubstituted aliphatic, alkenyl, aromatic, heteroaromatic, or siloxane moiety; and X is a polymerizable moiety.

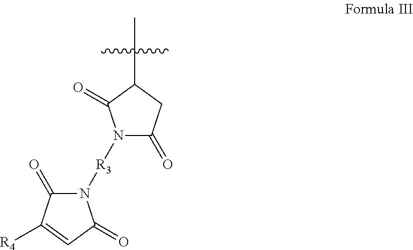

wherein:

R₃ is selected from the group consisting of a substituted or an unsubstituted aliphatic, alkenyl moiety having between 2 and 500 carbon atoms, aromatic, heteroaromatic and siloxane moieties; and

R₄ is selected from the group consisting of H and methyl;

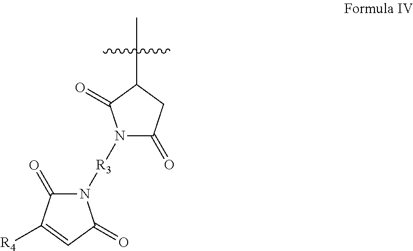

wherein:

R₃ is selected from the group consisting of a substituted or an unsubstituted aliphatic, alkenyl moiety having between 2 and 500 carbon atoms, aromatic, heteroaromatic and siloxane moieties; and

R₄ is selected from the group consisting of H and methyl;

A polymaleimide polymer comprising a plurality of repeating units having the structure:

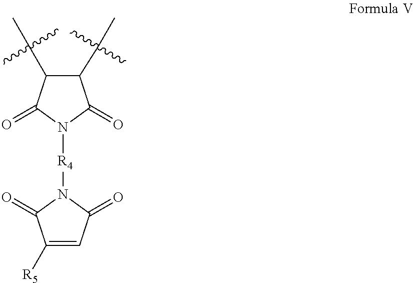

wherein:

R₄ is selected from the group consisting of a substituted or an unsubstituted aliphatic, alkenyl moiety having between 2 and about 500 carbon atoms, aromatic, heteroaromatic, or siloxane moieties; and

R₅ is selected from the group consisting of H and methyl;

Also contemplated is Compound I:

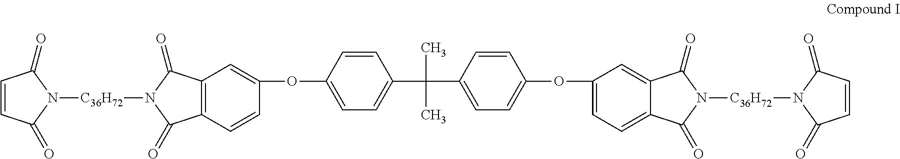

Maleimides are notable among thermoset resins due to the number of methods available to polymerize these materials. Due to the electron deficient nature of the maleimide double bond, maleimide compounds can undergo free-radical polymerization using standard peroxide initiators. The aliphatic maleimides are exceptional in that they are known to undergo UV-polymerization without the need for UV-initiators. Maleimide compounds also can undergo polymerization via Diels-Alder reactions and ene-reactions. The maleimide double bond also reacts with thiols, with amines via Michael reaction, as well as by anionic chain polymerization.

Polyethylene, polypropylene, and polybutadiene would be particularly useful, since these materials have dielectric constants around 2.2 and dissipation factors of around 0.0007. However, these materials are not able to cure into a polymer system and therefore they suffer from poor temperature performance. Polyethylene and polypropylene are available that have been grafted with maleic anhydride or oxidized to provide a carboxyl group for derivation. Polybutadienes are available that have been grafted with maleic anhydride; these materials are also available as alcohol terminated oligomers. The hydrogenated hydroxyl terminated polybutadienes are also available in a variety of molecular weights.

The maleated polyethylene and polypropylene, and oxidized (carboxyl functionalized) polyethylene are available in several different molecular weight ranges, as illustrated below:

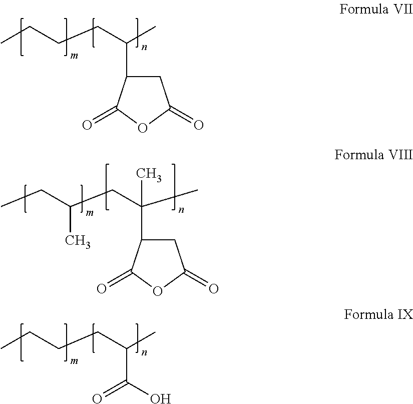

These starting materials have a functional group on the backbone, therefore one skilled in the art, through a series of chemical reactions can further react these groups to produce a variety of thermoset polymers that are capable of curing either through free-radical chemistry or via anionic or cationic polymerization techniques. All of these compounds are very hydrophobic and with very low surface energy and thus they would serve as an ideal adhesive for a variety of substrates. Along with low moisture uptake, the functionalized polyethylene and polypropylene should also give good film forming properties, low modulus, low dielectric constant, and low dissipation factor. The combination of a functionalized polyethylene or polypropylene with a maleimide terminated polyimide should also give very good cured films with enhanced properties, since the two materials can cure together, particularly very thermally stable polymers that have a TGA onset of decomposition of over 300° C.

Maleic anhydride functionalized polybutadienes can also be reacted with a variety of diamines and converted to maleimide-functionalized polyimides. Alcohol terminated species can also be reacted with a variety of compounds such as (meth)acrylic acid and maleimidoacids to produce thermoset resins that have very low dielectric constants and low dissipation factors, including unsaturated or saturated polybutadienes. Also, polyester oligomers containing the hydrogenated hydroxyl-terminated polybutadienes are very good resins for such applications.

The maleimide terminated polyimide resins have been cast into low modulus thin films, and the electrical properties have been measured. The dielectric constant was measured at approximately 2.5, which is very low and thus these films would be very good dielectric materials. The dissipation factor was measured at below 0.08, which number is also good, yet there may be room for improvement.

Maleimide-terminated polyimides are low modulus, high temperature stable, hydrophobic liquids and films, with low dielectric constants and low dissipation factors. In certain applications some modifications may be required to enhance their properties. In certain applications a higher glass transition temperature and lower coefficient of thermal expansion are required. In certain other applications the dielectric constants and dissipation factors need to be even lower. Flammability is always a very important issue in electronics applications, and additives are often added to keep flammability low.

Fluoropolymers are compounds known to have some of the lowest dielectric constants and dissipations factors. However, it is very difficult to get these compounds to adhere to other materials. The dielectric constant of polytetrafluoroethylene (PTFE; Teflon®) is approximately 2.1 and the dissipation factor is approximately 0.0002 over a wide frequency range. The glass transition temperature (T_{g}) of PTFE is approximately 115° C., and the coefficient of thermal expansion (CTE) is approximately 120. PTFE also has a very good flammability rating and is a self-extinguishing material. The formula of PTFE is shown below:

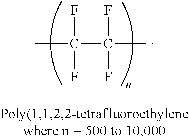

The maleimide-terminated polyimides of the invention have very low surface energy and are very compatible with PTFE. In fact, maleimide-terminated polyimides will wet PTFE. Therefore, PTFE can be used as a filler in many compositions to enhance the properties.

“Polyhedral Oligomeric Silsesquioxanes” (POSS), are caged silicones of the formula RSiO_{1.5} with various R functionalities. These nanocomposites have some advantageous properties such as lowering the melt viscosity and flow of various polymers. The caged structure also has a great deal of free volume. Since air or vacuum (i.e., free volume) has the lowest dielectric constant (1.0), the addition of these materials to the maleimide-terminated polyamide resins can lower the dielectric constant of the resin compositions. The addition of POSS nanoparticles to formulations of the present invention will also boost the T_{g} and lower the CTE of the maleimide-terminated polyimides. The POSS nanoparticles also have a very good flammability ratings and will reduce the flammability of the maleimide-terminated polyamide resin.

The use of the maleimide-terminated polyimides of the invention, either alone or in combination with the other described additives, gives very good performance films that are ideal for a wide variety of electronics packaging applications. These electronics applications include but are not limited to, flexible copper clad laminates, composite packaging, lithium-ion batteries construction, fuel cells and their construction, conformal coatings applications, die-attach pastes and film applications.

Thus, the present invention provides curable compositions comprising: at least one low dielectric constant, low dissipation factor resin; and at least one compound selected from the group consisting of: adhesion promoters, cure catalysts, inhibitors, fillers, fire retardants, and reactive diluents.

In certain embodiments, the at least one low dielectric constant, low dissipation factor resin comprises a maleimide-terminated polyimide, For example, the maleimide-terminated polyimide can be selected from the group consisting of:

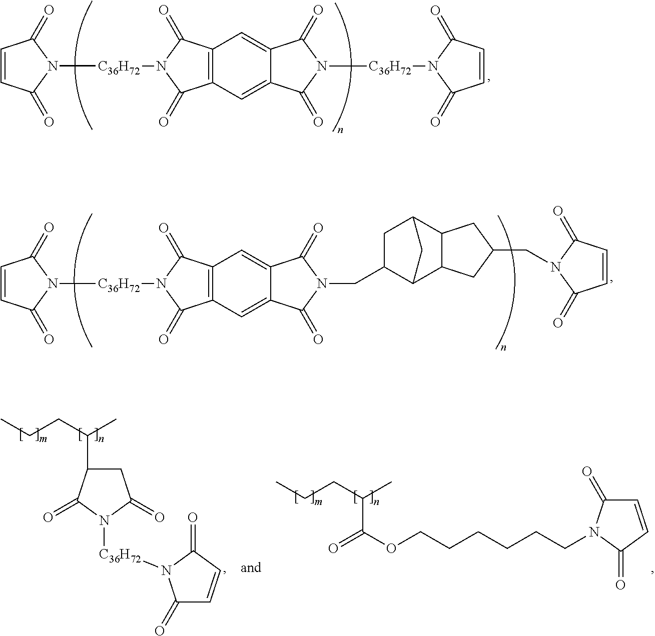

wherein

the value of m is an interger from 50-1000; and

the value of n is an interger from 1-10.

In other aspects, the maleimide-terminated polyimide has a formula selected from the group consisting of Formulae I, III, IV and VI:

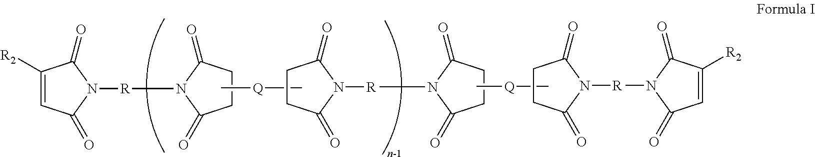

where each of R and Q is independently a substituted or an unsubstituted aliphatic, alkenyl, aromatic, heteroaromatic, or siloxane moiety; R₂ is H or methyl; and n is an integer having the value between 1 and about 10;

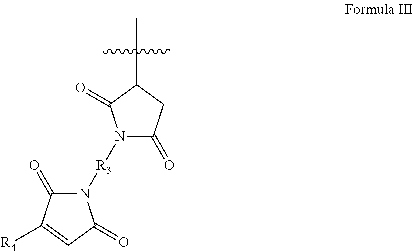

wherein:

R₃ is selected from the group consisting of a substituted or an unsubstituted aliphatic, alkenyl moiety having between 2 and 500 carbon atoms, aromatic, heteroaromatic and siloxane moieties; and

R₄ is selected from the group consisting of H and methyl;

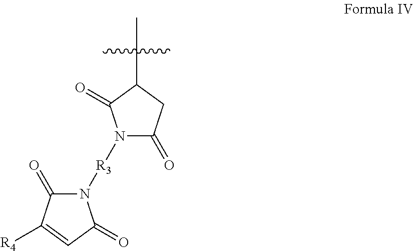

wherein:

R₃ is selected from the group consisting of a substituted or an unsubstituted aliphatic, alkenyl moiety having between 2 and 500 carbon atoms, aromatic, heteroaromatic and siloxane moieties; and

R₄ is selected from the group consisting of H and methyl;

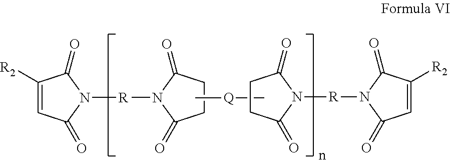

wherein, R and Q are each independently substituted or unsubstituted aliphatic, alkenyl, aromatic, heteroaromatic, or siloxane moiety;

R₂ is H or methyl; and n is 1 to about 10;

or is a polymaleimide polymer comprising a plurality of repeating units having the structure:

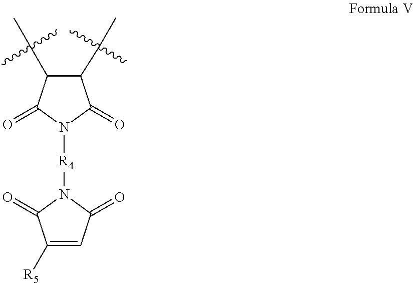

wherein:

R₄ is selected from the group consisting of a substituted or an unsubstituted aliphatic, alkenyl moiety having between 2 and about 500 carbon atoms, aromatic, heteroaromatic, or siloxane moieties; and

R₅ is selected from the group consisting of H and methyl.

In other embodiments, the at least one low dielectric constant, low dissipation factor resin comprises a compound of Formula II:

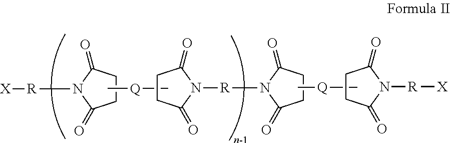

wherein each of R and Q is independently a substituted or an unsubstituted aliphatic, alkenyl, aromatic, heteroaromatic, or siloxane moiety; and X is a polymerizable moiety.

In additional embodiments, the at least one low dielectric constant, low dissipation factor resin comprises a functionalized polyethylene compound. For example, the functionalized polyethylene can be a compound can the structure of Formula VI:

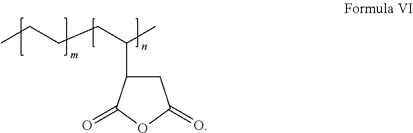

In certain aspects, wherein the functionalized polyethylene compound is an oxidized polyethylene compound, such as a compound have the structure of Formula VIII:

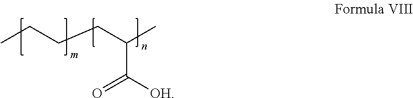

In yet further embodiments, the at least one low dielectric constant, low dissipation factor resin comprises a functionalized polypropylene compound, such as a compound the structure of Formula VII:

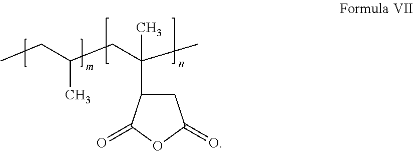

In additional embodiments, the at least one low dielectric constant, low dissipation factor resin comprises a functionalized polybutadiene compound, or the at least one low dielectric constant, low dissipation factor resin comprises a functionalized curable imide-lined polyimide; or

The at least one low dielectric constant, low dissipation factor resin can also comprise at least one compound selected from Formulae X-XVI:

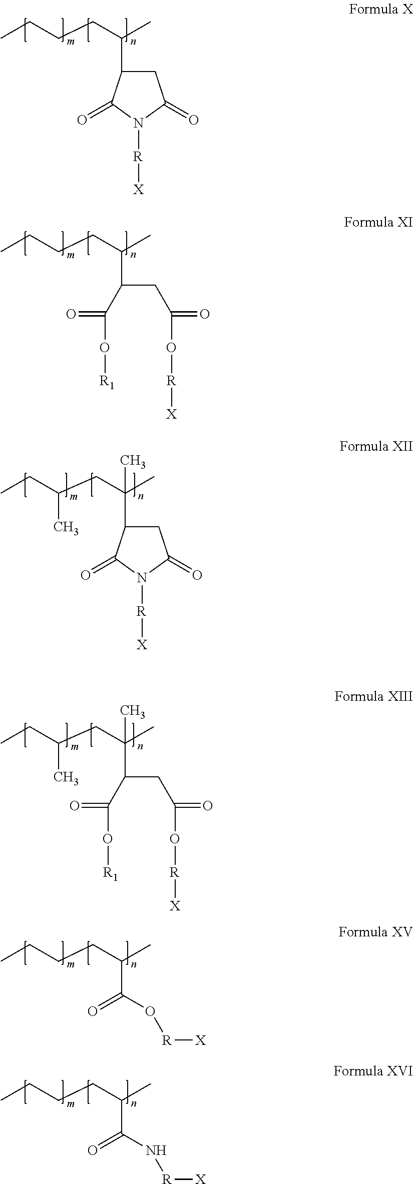

wherein, R₁ is H, methyl, alkyl, alkenyl, cycloalkenyl, cycloalkyl, heterocyclic, aryl, or heteroaryl, and

R is independently substituted or unsubstituted aliphatic, aromatic, heteroaromatic, siloxane, unsaturated hydrocarbon, polyester, polyamide, polyurethane moieties, alkyl, alkenyl, alkynyl, hydroxy, oxo, alkoxy, mercapto, cycloalkyl, substituted cycloalkyl, heterocyclic, substituted heterocyclic, aryl, substituted aryl, heteroaryl, substituted heteroaryl, aryloxy, substituted aryloxy, halogen, haloalkyl, cyano, nitro, nitrone, amino, amido, —C(O)H, —C(O)—, —S—, —S(O)2-, —OC(O)—O—, —NR—C(O)—, —NR—C(O)—NR—, and —OC(O)—NR—, H, lower alkyl, acyl, oxyacyl, carboxyl, carbamate, sulfonyl, sulfonamide, sulfuryl, and the like, and X is a polymerizable or curative moiety.

In certain aspects of the invention the at least one low dielectric constant, low dissipation factor resin can comprises an oligomer selected from the group consisting of:

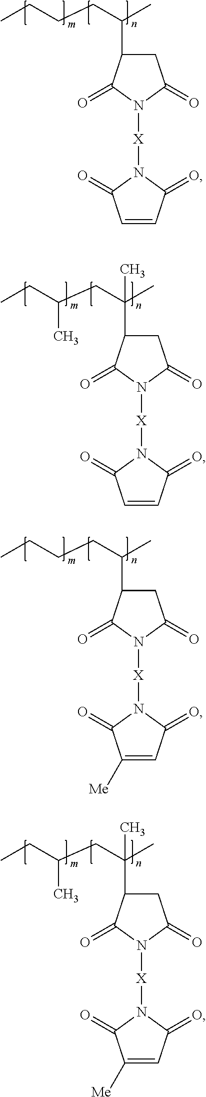

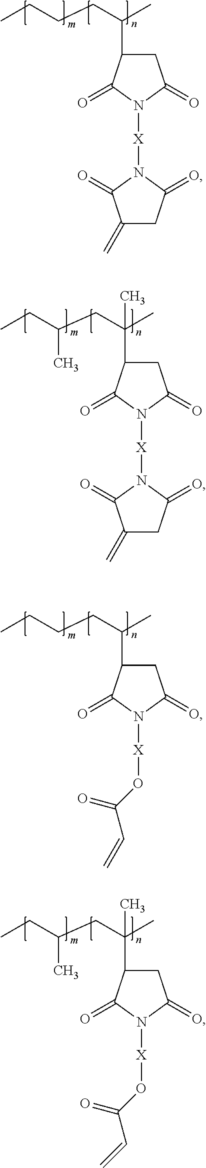

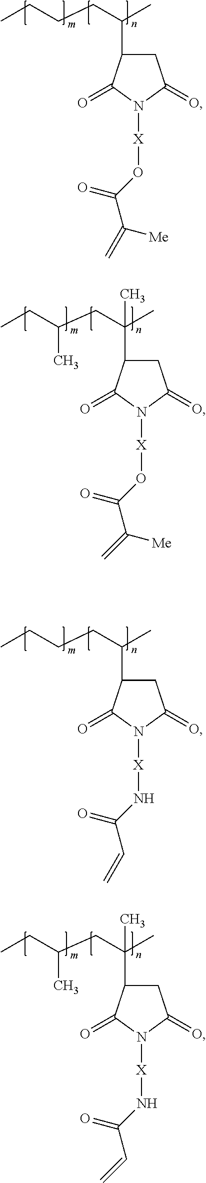

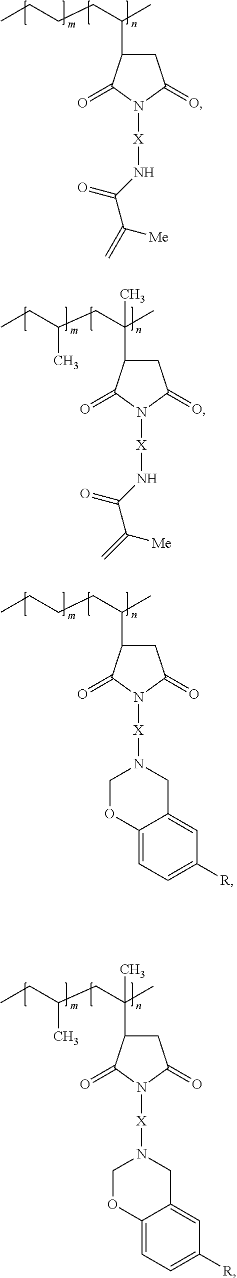

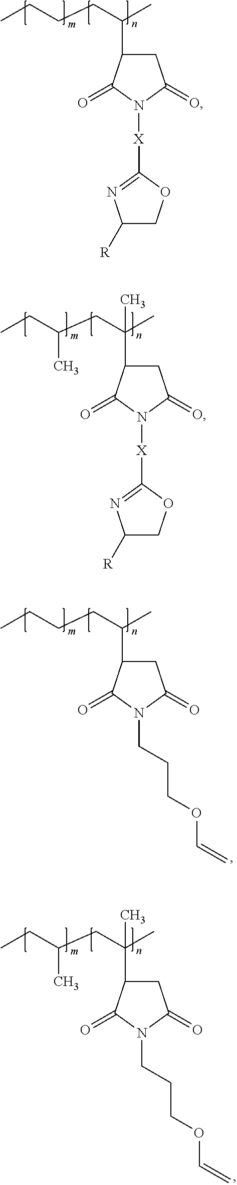

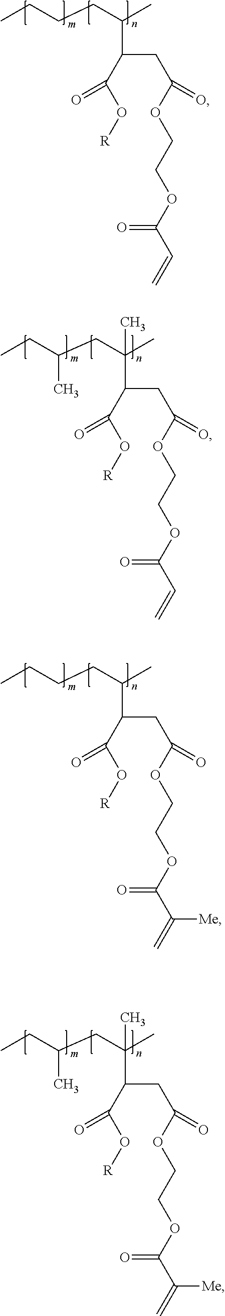

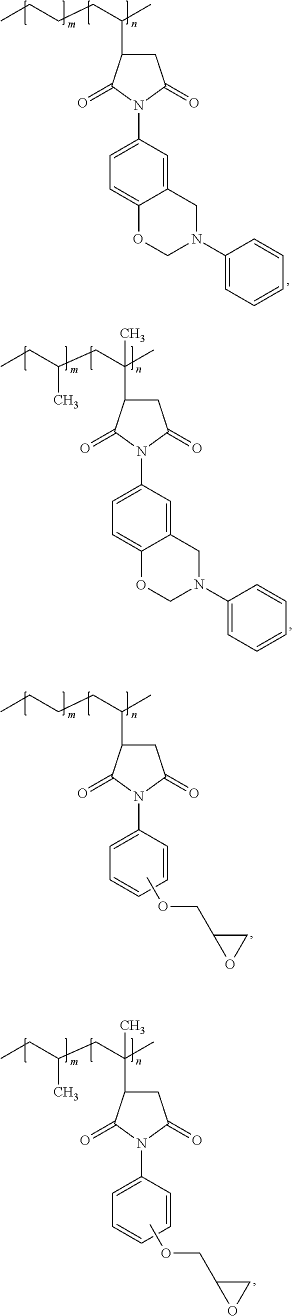

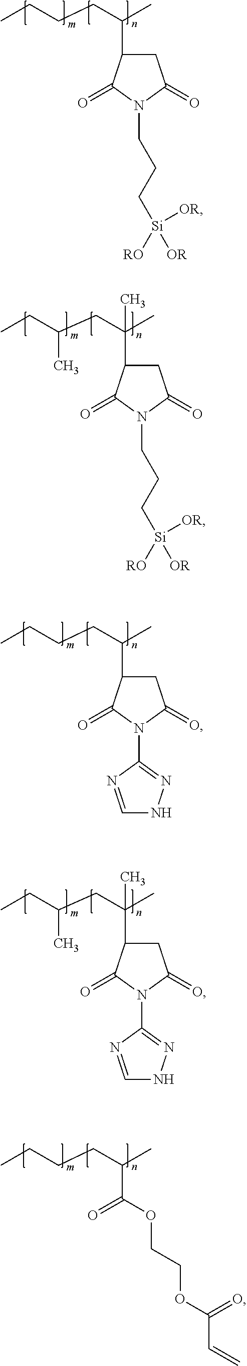

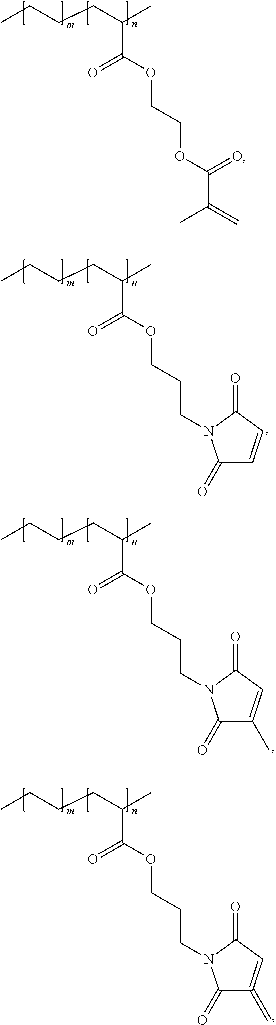

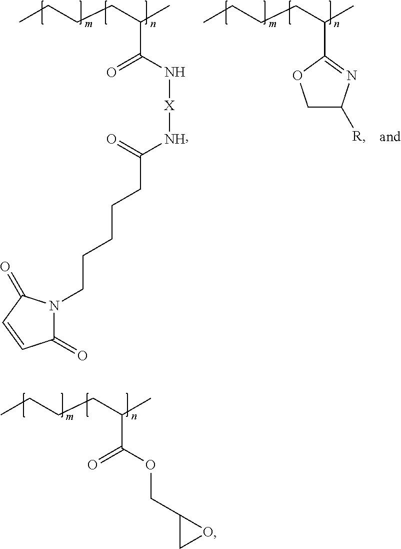

wherein

the value of m is an interger from 50-1000; and

the value of n is an interger from 1-10.

The compositions of the invention can include a such as a perfluorinated hydrocarbon, for example polytetrafluoroethylene, having the structural formula:

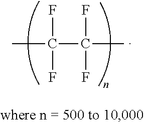

In other aspects, the filler is a Polyhedral Oligomeric Silsesquioxane (POSS) nanoparticle, such as a POSS selected from the group consisting of: an epoxy cyclohexyl POSS, an acrylo propyl POSS, an octylisobutyl POSS, an octadimethylsilane POSS, trisilanophenyl POSS, an aminopropyl isobutyl POSS, a glycidyl POSS, a dodecaphenyl POSS, an octatetramethyl ammonium POSS, a trisilanol isobutyl POSS, an N-phenyl aminopropyl POSS, a methacryl POSS, an isooctyl POSS, a polyethylene glycol POSS, a trisilanol isooctyl POSS, and combinations thereof.

The present invention also provides films comprising a composition according to the invention, which typically has a low dielectric constant and a low dissipation factor, and may be a microelectronics film.

Also provided are coatings comprising an invention composition which typically has a low dielectric constant and a low dissipation factor and may be a microelectronics coating. In certain aspects, the coating the coating is a conformal coating, which may be a coating on high power transmission cables, poles, or attachments.

Also encompassed by the present invention are fuel cells, flexible copper clad laminates, and lithium-ion batteries, constructed with the invention compositions, which will typically have a low dielectric constant and a low dissipation factor.

The present invention further provides die-attach paste, die-attach films, and composite packaging, each of which can have a low dielectric constant and a low dissipation factor can and may be used in the electronics or microelectronics industries.

In yet further aspects of the invention, protective layers are provided that comprise the invention compositions, typically have a low dielectric constant and a low dissipation factor and may be used, for example in down-hole oil exploration applications.

Additionally, the present invention provides pipe lining comprising the composition of the invention, such as provides pipe lining having a low dielectric constant and a low dissipation factor. Such pipe linings may be use in oil exploration.

Also included in the present invention are aircraft or marine craft constructed using the compositions describe herein, which will typically have a low dielectric constant and a low dissipation factor.

The invention also includes composites that comprising the compositions described herein, that typically have a low dielectric constant and a low dissipation factor and can be used, for example, in wind turbines.

### DETAILED DESCRIPTION

It is to be understood that both the foregoing general description and the following detailed description are exemplary and explanatory only and are not restrictive of the invention claimed. As used herein, the use of the singular includes the plural unless specifically stated otherwise. As used herein, “or” means “and/or” unless stated otherwise. Furthermore, use of the term “including” as well as other forms, such as “includes,” and “included,” is not limiting.

The section headings used herein are for organizational purposes only and are not to be construed as limiting the subject matter described.

Unless specific definitions are provided, the nomenclatures utilized in connection with, and the laboratory procedures and techniques of analytical chemistry, synthetic organic and inorganic chemistry described herein are those known in the art, such as those set forth in “IUPAC Compendium of Chemical Terminology: IUPAC Recommendations (The Gold Book)” (McNaught ed.; International Union of Pure and Applied Chemistry, 2^{nd} Ed., 1997) and “Compendium of Polymer Terminology and Nomenclature: IUPAC Recommendations 2008” (Jones et al., eds; International Union of Pure and Applied Chemistry, 2009). Standard chemical symbols are used interchangeably with the full names represented by such symbols. Thus, for example, the terms “hydrogen” and “H” are understood to have identical meaning Standard techniques may be used for chemical syntheses, chemical analyses, and formulation.

### DEFINITIONS

“About” as used herein means that a number referred to as “about” comprises the recited number plus or minus 1-10% of that recited number. For example, “about” 100 degrees can mean 95-105 degrees or as few as 99-101 degrees depending on the situation. Whenever it appears herein, a numerical range such as “1 to 20” refers to each integer in the given range; e.g., “1 to 20 carbon atoms” means that an alkyl group can contain only 1 carbon atom, 2 carbon atoms, 3 carbon atoms, etc., up to and including 20 carbon atoms (although the term “alkyl” also includes instances where no numerical range of carbon atoms is designated).

“Adhesive” or “adhesive compound” as used herein, refers to any substance that can adhere or bond two items together. Implicit in the definition of an “adhesive composition” or “adhesive formulation” is the fact that the composition or formulation is a combination or mixture of more than one species, component or compound, which can include adhesive monomers, oligomers, and/or polymers along with other materials, whereas an “adhesive compound” refers to a single species, such as an adhesive polymer or oligomer.

More specifically, adhesive composition refers to un-cured mixtures in which the individual components in the mixture retain the chemical and physical characteristics of the original individual components of which the mixture is made. Adhesive compositions are typically malleable and may be liquids, paste, gel or another form that can be applied to an item so that it can be bonded to another item.

“Cured adhesive,” “cured adhesive composition” or “cured adhesive compound” refers to adhesives components and mixtures obtained from reactive curable original compound(s) or mixture(s) thereof which have undergone a chemical and/or physical changes such that the original compound(s) or mixture(s) is (are) transformed into a solid, substantially non-flowing material. A typical curing process may involve crosslinking.

“Curable” means that an original compound(s) or composition material(s) can be transformed into a solid, substantially non-flowing material by means of chemical reaction, crosslinking, radiation crosslinking, or the like. Thus, adhesive compositions of the invention are curable, but unless otherwise specified, the original compound(s) or composition material(s) is (are) not cured.

“Photoimageable”, as used herein, refers to the ability of a compound or composition to be selectively cured only in areas exposed to light. The exposed areas of the compound are thereby rendered cured and insoluble, while the unexposed area of the compound or composition remains un-cured and therefore soluble in a developer solvent. Typically, this operation is conducted using ultraviolet light as the light source and a photomask as the means to define where the exposure occurs. The selective patterning of dielectric layers on a silicon wafer can be carried out in accordance with various photolithographic techniques known in the art. In one method, a photosensitive polymer film is applied over the desired substrate surface and dried. A photomask containing the desired patterning information is then placed in close proximity to the photoresist film. The photoresist is irradiated through the overlying photomask by one of several types of imaging radiation including UV light, e-beam electrons, x-rays, or ion beam. Upon exposure to the radiation, the polymer film undergoes a chemical change (crosslinks) with concomitant changes in solubility. After irradiation, the substrate is soaked in a developer solution that selectively removes the non-crosslinked or unexposed areas of the film.

“Conformal coatings” as used herein, refers to a material applied to electronic circuitry to act as protection against moisture, dust, chemicals, and temperature extremes that, if uncoated, could result in damage or failure of the electronics to function properly. Typically, electronics assemblies are coated with a layer of transparent conformal coating to protect the electronics from harsh environment. Furthermore, a suitably chosen material coating has to be able to reduce the effects of mechanical stress and vibration on the circuit and its ability to cope in extreme temperatures. For example, in a chip-on-board assembly process, a silicon die is mounted on the board with adhesive or a soldering process, and then electrically connected by wire bonding. To protect the very delicate package, the whole thing is encapsulated in a conformal coating called a “glob top”.

“Interlayer Dielectric Layer” (ILD) refers to a layer of dielectric material disposed over a first pattern of conductive traces and between such first pattern and a second pattern of conductive traces. Such ILD layer is typically patterned to form openings therein (generally referred to as “vias”) to provide for electrical contact between the first and second patterns of conductive traces in specific regions. Other regions of such ILD layer are devoid of vias and thus prevent electrical contact between the conductive traces of the first and second patterns in such other regions.

“Flexible Copper Clad Laminate” (FCCL) refers to a laminate composed of a low dielectric polymer with adhesive layer laminated with a thin copper sheet. The laminate can be single layer, double layer or multi-layer. A cover layer is also applied that can be imprinted with a pattern and the copper can then be etched away to form a flexible circuit board.

“Thermoplastic,” as used herein, refers to the ability of a compound, composition or other material (e.g. a plastic) to dissolve in a suitable solvent or to melt to a liquid when heated and freeze to a solid, often brittle and glassy, state when cooled sufficiently.

“Thermoset,” as used herein, refers to the ability of a compound, composition or other material to irreversibly “cure” resulting in a single three-dimensional network that has greater strength and less solubility compared to the non-cured product. Thermoset materials are typically polymers that may be cured, for example, through heat (e.g. above 200° Celsius), via a chemical reaction (e.g. epoxy ring-opening, free-radical polymerization, etc or through irradiation (e.g. visible light, UV light, electron beam radiation, ion-beam radiation, or X-ray irradiation).

Thermoset materials, such as thermoset polymers or resins, are typically liquid or malleable forms prior to curing, and therefore may be molded or shaped into their final form, and/or used as adhesives. Curing transforms the thermoset resin into a rigid infusible and insoluble solid or rubber by a cross-linking process. Thus, energy and/or catalysts are typically added that cause the molecular chains to react at chemically active sites (unsaturated or epoxy sites, for example), linking the polymer chains into a rigid, 3-D structure. The cross-linking process forms molecules with a higher molecular weight and resultant higher melting point. During the reaction, when the molecular weight of the polymer has increased to a point such that the melting point is higher than the surrounding ambient temperature, the polymer becomes a solid material.

“Cross-linking,” as used herein, refers to the attachment of two or more oligomer or longer polymer chains by bridges of an element, a molecular group, a compound, or another oligomer or polymer. Crosslinking may take place upon heating or exposure to light; some crosslinking processes may also occur at room temperature or a lower temperature. As cross-linking density is increased, the properties of a material can be changed from thermoplastic to thermosetting.

As used herein, “B-stageable” refers to the properties of an adhesive having a first solid phase followed by a tacky rubbery stage at elevated temperature, followed by yet another solid phase at an even higher temperature. The transition from the tacky rubbery stage to the second solid phase is thermosetting. However, prior to thermosetting, the material behaves similarly to a thermoplastic material. Thus, such adhesives allow for low lamination temperatures while providing high thermal stability.

A “die” or “semiconductor die” as used herein, refers to a small block of semiconducting material, on which a functional circuit is fabricated.

A “flip-chip” semiconductor device is one in which a semiconductor die is directly mounted to a wiring substrate, such as a ceramic or an organic printed circuit board. Conductive terminals on the semiconductor die, usually in the form of solder bumps, are directly physically and electrically connected to the wiring pattern on the substrate without use of wire bonds, tape-automated bonding (TAB), or the like. Because the conductive solder bumps making connections to the substrate are on the active surface of the die or chip, the die is mounted in a face-down manner, thus the name “flip-chip.”

“Underfill,” “underfill composition” and “underfill material” are used interchangeably to refer to a material, typically polymeric compositions, used to fill gaps between a semiconductor component, such as a semiconductor die, and a substrate. “Underfilling” refers to the process of applying an underfill composition to a semiconductor component-substrate interface, thereby filling the gaps between the component and the substrate.

The term “monomer” refers to a molecule that can undergo polymerization or copolymerization thereby contributing constitutional units to the essential structure of a macromolecule (a polymer).

“Polymer” and “polymer compound” are used interchangeably herein, to refer generally to the combined the products of a single chemical polymerization reaction. Polymers are produced by combining monomer subunits into a covalently bonded chain. Polymers that contain only a single type of monomer are known as “homopolymers,” while polymers containing a mixture of monomers are known as “copolymers.”

The term “copolymers” is inclusive of products that are obtained by copolymerization of two monomer species, those obtained from three monomers species (terpolymers), those obtained from four monomers species (quaterpolymers), etc. It is well known in the art that copolymers synthesized by chemical methods include, but are not limited to, molecules with the following types of monomer arrangements:

alternating copolymers, which contain regularly alternating monomer residues;

periodic copolymers, which have monomer residue types arranged in a repeating sequence;

random copolymers, which have a random sequence of monomer residue types;

statistical copolymers, which have monomer residues arranged according to a known statistical rule;

block copolymers, which have two or more homopolymer subunits linked by covalent bonds. The blocks of homopolymer within block copolymers, for example, can be of any length and can be blocks of uniform or variable length. Block copolymers with two or three distinct blocks are called diblock copolymers and triblock copolymers, respectively; and

star copolymers, which have chains of monomer residues having different constitutional or configurational features that are linked through a central moiety.

The skilled artisan will appreciate that a single copolymer molecule may have different regions along its length that can be characterized as an alternating, periodic, random, etc. A copolymer product of a chemical polymerization reaction may contain individual polymeric fragments that each differ in the arrangement of monomer units. The skilled artisan will further be knowledgeable in methods for synthesizing each of these types of copolymers, and for varying reaction conditions to favor one type over another.

Furthermore, the length of a polymer chain according to the present invention will typically vary over a range or average size produced by a particular reaction. The skilled artisan will be aware, for example, of methods for controlling the average length of a polymer chain produced in a given reaction and also of methods for size-selecting polymers after they have been synthesized.

Unless a more restrictive term is used, polymer is intended to encompass homopolymers, and copolymers having any arrangement of monomer subunits as well as copolymers containing individual molecules having more than one arrangement. With respect to length, unless otherwise indicated, any length limitations recited for the polymers described herein are to be considered averages of the lengths of the individual molecules in polymer.

“Thermoplastic elastomer” or “TPE”, as used herein refers to a class of copolymers that consist of materials with both thermoplastic and elastomeric properties.

“Hard blocks” or “hard segments” as used herein refer to a block of a copolymer (typically a thermoplastic elastomer) that is hard at room temperature by virtue of a high melting point (Tm) or T_{g}. By contrast, “soft blocks” or “soft segments” have a T_{g} below room temperature. T_{g}

As used herein, “oligomer” or “oligomeric” refers to a polymer having a finite and moderate number of repeating monomers structural units. Oligomers of the invention typically have 2 to about 100 repeating monomer units; frequently 2 to about 30 repeating monomer units; and often 2 to about 10 repeating monomer units; and usually have a molecular weight up to about 3,000.

“Tackifier” as used herein, refers to chemical compounds used in formulating adhesives to increase the “tack” (the stickiness of the surface of the adhesive). They are usually low-molecular weight compounds with high glass transition temperature. At low strain rate, they provide higher stress compliance, and become stiffer at higher strain rate. The higher glass transition temperature of these materials provides the adhesive with suitable viscoelastic properties.

The skilled artisan will appreciate that oligomers and polymers may, depending on the availability of polymerizable groups or side chains, subsequently be incorporated as monomers in further polymerization or crosslinking reactions.

As used herein, “aliphatic” refers to any alkyl, alkenyl, cycloalkyl, or cycloalkenyl moiety.

“Aromatic hydrocarbon” or “aromatic” as used herein, refers to compounds having one or more benzene rings.

“Alkane,” as used herein, refers to saturated straight-chain, branched or cyclic hydrocarbons having only single bonds. Alkanes have general formula CₙH₂ₙ₊₂.

“Cycloalkane,” refers to an alkane having one or more rings in its structure.

As used herein, “alkyl” refers to straight or branched chain hydrocarbyl groups having from 1 up to about 500 carbon atoms. “Lower alkyl” refers generally to alkyl groups having 1 to 6 carbon atoms. The terms “alkyl” and “substituted alkyl” include, respectively, substituted and unsubstituted C₁-C₅₀₀ straight chain saturated aliphatic hydrocarbon groups, substituted and unsubstituted C₂-C₂₀₀ straight chain unsaturated aliphatic hydrocarbon groups, substituted and unsubstituted C₄-C₁₀₀ branched saturated aliphatic hydrocarbon groups, substituted and unsubstituted C₁-C₅₀₀ branched unsaturated aliphatic hydrocarbon groups.

For example, the definition of “alkyl” includes but is not limited to: methyl (Me), ethyl (Et), propyl (Pr), butyl (Bu), pentyl, hexyl, heptyl, octyl, nonyl, decyl, undecyl, ethenyl, propenyl, butenyl, penentyl, hexenyl, heptenyl, octenyl, nonenyl, decenyl, undecenyl, isopropyl (i-Pr), isobutyl (i-Bu), tert-butyl (t-Bu), sec-butyl (s-Bu), isopentyl, neopentyl, cyclopropyl, cyclobutyl, cycloheptyl, cyclohexyl, cycloheptyl, cyclooctyl, cyclopentenyl, cyclohexenyl, cycloheptenyl, cyclooctenyl, methylcyclopropyl, ethylcyclohexenyl, butenylcyclopentyl, tricyclodecyl, adamantyl, norbornyl and the like.

“Substituted alkyl” refers to alkyl moieties bearing substituents that include but are not limited to alkyl, alkenyl, alkynyl, hydroxy, oxo, alkoxy, mercapto, cycloalkyl, substituted cycloalkyl, heterocyclic, substituted heterocyclic, aryl, substituted aryl (e.g., arylC₁₋₁₀alkyl or arylC₁₋₁₀ alkyloxy), heteroaryl, substituted heteroaryl (e.g., heteroarylC₁₋₁₀ alkyl), aryloxy, substituted aryloxy, halogen, haloalkyl (e.g., trihalomethyl), cyano, nitro, nitrone, amino, amido, carbamoyl, ═O, ═CH—, —C(O)H, —C(O)O—, —C(O)—, —S—, —S(O)₂, —OC(O)—O—, —NR—C(O), —NR—C(O)—NR, —OC(O)—NR, where R is H or lower alkyl, acyl, oxyacyl, carboxyl, carbamate, sulfonyl, sulfonamide, sulfuryl, C₁₋₁₀alkylthio, arylC₁₋₁₀alkylthio, C₁₋₁₀alkylamino, arylC₁₋₁₀alkylamino, N-aryl-N—C₁₋₁₀alkylamino, C₁₋₁₀alkyl carbonyl, arylC₁₋₁₀alkylcarbonyl, C₁₋₁₀ alkylcarboxy, aryl C₁₋₁₀alkylcarboxy, C₁₋₁₀alkyl carbonylamino, aryl C₁₋₁₀alkylcarbonylamino, tetrahydrofuryl, morpholinyl, piperazinyl, and hydroxypyronyl.

In addition, as used herein “C₃₆” refers to all possible structural isomers of a 36 carbon aliphatic moiety, including branched isomers and cyclic isomers with up to three carbon-carbon double bonds in the backbone. One non-limiting example of a moiety that the definition of “C₃₆” refers to is the moiety comprising a cyclohexane-based core and four long “arms” attached to the core, as demonstrated by the following structure:

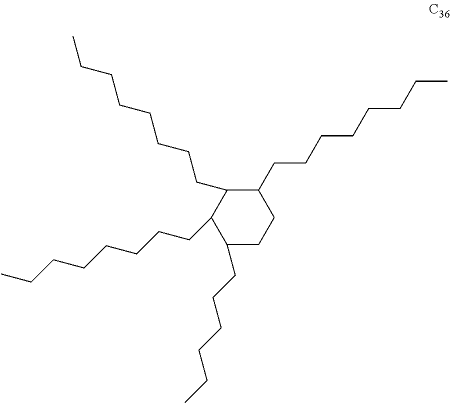 [SMILES: CCCCCCCCC1CCC(CCCCCC)C(CCCCCCCC)C1CCCCCCCC]

As used herein, “cycloalkyl” refers to cyclic ring-containing groups containing in the range of about 3 up to about 20 carbon atoms, typically 3 to about 15 carbon atoms. In certain embodiments, cycloalkyl groups have in the range of about 4 up to about 12 carbon atoms, and in yet further embodiments, cycloalkyl groups have in the range of about 5 up to about 8 carbon atoms. and “substituted cycloalkyl” refers to cycloalkyl groups further bearing one or more substituents as set forth below.

As used herein, the term “aryl” represents an unsubstituted, mono-, di- or trisubstituted monocyclic, polycyclic, biaryl aromatic groups covalently attached at any ring position capable of forming a stable covalent bond, certain preferred points of attachment being apparent to those skilled in the art (e.g., 3-phenyl, 4-naphtyl and the like). The aryl substituents are independently selected from the group consisting of halo, —OH, —SH, —CN, —NO₂, trihalomethyl, hydroxypyronyl, C₁₋₁₀alkyl, arylC₁₋₁₀alkyl, C₁₋₁₀alkyloxyC₁₋₁₀alkyl, arylC₁₋₁₀alkyloxyC₁₋₁₀alkyl, C₁₋₁₀alkylthioC₁₋₁₀alkyl, arylC₁₋₁₀alkylthioC₁₋₁₀alkyl, C₁₋₁₀alkylaminoC₁₋₁₀alkyl, arylC₁₋₁₀ alkylaminoC₁₋₁₀alkyl, N-aryl-N—C₁₋₁₀alkylaminoC₁₋₁₀alkyl, C₁₋₁₀alkylcarbonylC₁₋₁₀ alkyl, aryl C₁₋₁₀alkylcarbonyl C₁₋₁₀alkyl, C₁₋₁₀alkylcarboxyC₁₋₁₀alkyl, arylC₁₋₁₀alkylcarboxyC₁₋₁₀alkyl, C₁₋₁₀ alkylcarbonylaminoC₁₋₁₀alkyl, and arylC₁₋₁₀alkylcarbonylaminoC₁₋₁₀alkyl.

Some specific examples of moieties encompassed by the definition of “aryl” include but are not limited to phenyl, biphenyl, naphthyl, dihydronaphthyl, tetrahydronaphthyl, indenyl, indanyl, azulenyl, anthryl, phenanthryl, fluorenyl, pyrenyl and the like. “Substituted aryl” refers to aryl groups further bearing one or more substituents as set forth below.

As used herein, “arylene” refers to a divalent aryl moiety. “Substituted arylene” refers to arylene moieties bearing one or more substituents as set forth above.

As used herein, “alkylaryl” refers to alkyl-substituted aryl groups and “substituted alkylaryl” refers to alkylaryl groups further bearing one or more substituents as set forth below.

As used herein, “arylalkyl” refers to aryl-substituted alkyl groups and “substituted arylalkyl” refers to arylalkyl groups further bearing one or more substituents as set forth below. Some examples of included but are not limited to (4-hydroxyphenyl)ethyl, or (2-aminonaphthyl) hexenyl.

As used herein, “arylalkenyl” refers to aryl-substituted alkenyl groups and “substituted arylalkenyl” refers to arylalkenyl groups further bearing one or more substituents as set forth below.

As used herein, “arylalkynyl” refers to aryl-substituted alkynyl groups and “substituted arylalkynyl” refers to arylalkynyl groups further bearing one or more substituents as set forth below.

As used herein, “aroyl” refers to aryl-carbonyl species such as benzoyl and “substituted aroyl” refers to aroyl groups further bearing one or more substituents as set forth below.

As used herein, “hetero” refers to groups or moieties containing one or more heteroatoms such as N, O, Si and S. Thus, for example “heterocyclic” refers to cyclic (i.e., ring-containing) groups having e.g. N, O, Si or S as part of the ring structure, and having in the range of 3 up to 14 carbon atoms. “Heteroaryl” and “heteroalkyl” moieties are aryl and alkyl groups, respectively, containing e.g. N, O, Si or S as part of their structure. The terms “heteroaryl”, “heterocycle” or “heterocyclic” refer to a monovalent unsaturated group having a single ring or multiple condensed rings, from 1 to 8 carbon atoms and from 1 to 4 hetero atoms selected from nitrogen, sulfur or oxygen within the ring.

The definition of heteroaryl includes but is not limited to thienyl, benzothienyl, isobenzothienyl, 2,3-dihydrobenzothienyl, furyl, pyranyl, benzofuranyl, isobenzofuranyl, 2,3-dihydrobenzofuranyl, pyrrolyl, pyrrolyl-2,5-dione, 3-pyrrolinyl, indolyl, isoindolyl, 3H-indolyl, indolinyl, indolizinyl, indazolyl, phthalimidyl (or isoindoly-1,3-dione), imidazolyl. 2H-imidazolinyl, benzimidazolyl, pyridyl, pyrazinyl, pyradazinyl, pyrimidinyl, triazinyl, quinolyl, isoquinolyl, 4H-quinolizinyl, cinnolinyl, phthalazinyl, quinazolinyl, quinoxalinyl, 1,8-naphthyridinyl, pteridinyl, carbazolyl, acridinyl, phenazinyl, phenothiazinyl, phenoxazinyl, chromanyl, benzodioxolyl, piperonyl, purinyl, pyrazolyl, triazolyl, tetrazolyl, thiazolyl, isothiazolyl, benzthiazolyl, oxazolyl, isoxazolyl, benzoxazolyl, oxadiazolyl, thiadiazolyl, pyrrolidinyl-2,5-dione, imidazolidinyl-2,4-dione, 2-thioxo-imidazolidinyl-4-one, imidazolidinyl-2,4-dithione, thiazolidinyl-2,4-dione, 4-thioxo-thiazolidinyl-2-one, piperazinyl-2,5-dione, tetrahydro-pyridazinyl-3,6-dione, 1,2-dihydro-[1,2,4,5]tetrazinyl-3,6-dione, [1,2,4,5]tetrazinanyl-3,6-dione, dihydro-pyrimidinyl-2,4-dione, pyrimidinyl-2,4,6-trione, 1H-pyrimidinyl-2,4-dione, 5-iodo-1H-pyrimidinyl-2,4-dione, 5-chloro-1H-pyrimidinyl-2,4-dione, 5-methyl-1H-pyrimidinyl-2,4-dione, 5-isopropyl-1H-pyrimidinyl-2,4-dione, 5-propynyl-1H-pyrimidinyl-2,4-dione, 5-trifluoromethyl-1H-pyrimidinyl-2,4-dione, 6-amino-9H-purinyl, 2-amino-9H-purinyl, 4-amino-1H-pyrimidinyl-2-one, 4-amino-5-fluoro-1H-pyrimidinyl-2-one, 4-amino-5-methyl-1H-pyrimidinyl-2-one, 2-amino-1,9-dihydro-purinyl-6-one, 1,9-dihydro-purinyl-6-one, 1H-[1,2,4]triazolyl-3-carboxylic acid amide, 2,6-diamino-N.sub.6-cyclopropyl-9H-purinyl, 2-amino-6-(4-methoxyphenylsulfanyl)-9H-purinyl, 5,6-dichloro-1H-benzoimidazolyl, 2-isopropylamino-5,6-dichloro-1H-benzoimidazolyl, 2-bromo-5,6-dichloro-1H-benzoimidazolyl, and the like. Furthermore, the term “saturated heterocyclic” represents an unsubstituted, mono-, di- or trisubstituted monocyclic, polycyclic saturated heterocyclic group covalently attached at any ring position capable of forming a stable covalent bond, certain preferred points of attachment being apparent to those skilled in the art (e.g., 1-piperidinyl, 4-piperazinyl and the like).

Hetero-containing groups may also be substituted. For example, “substituted heterocyclic” refers to a ring-containing group having in the range of 3 up to 14 carbon atoms that contains one or more heteroatoms and also bears one or more substituents, as set forth above. Examples of substituents include, but are not limited to halo, —OH, —SH, —CN, —NO₂, trihalomethyl, hydroxypyronyl, C₁₋₁₀alkyl, arylC₁₋₁₀alkyl, C₁₋₁₀alkyloxyC₁₋₁₀alkyl, arylC₁₋₁₀ alkyloxy C₁₋₁₀alkyl, C₁₋₁₀alkylthioC₁₋₁₀alkyl, arylC₁₋₁₀alkylthioC₁₋₁₀alkyl, C₁₋₁₀alkylaminoC₁₋₁₀ alkyl, arylC₁₋₁₀alkylamino C₁₋₁₀alkyl, N-aryl-N—C₁₋₁₀alkylaminoC₁₋₁₀alkyl, C₁₋₁₀alkylcarbonylC₁₋₁₀alkyl, arylC₁₋₁₀alkylcarbonyl C₁₋₁₀alkyl, C₁₋₁₀alkylcarboxyC₁₋₁₀alkyl, arylC₁₋₁₀alkylcarboxyC₁₋₁₀alkyl C₁₋₁₀alkylcarbonylaminoC₁₋₁₀alkyl, and arylC₁₋₁₀alkylcarbonylamino C₁₋₁₀alkyl.

As used herein, the term “phenol” includes compounds having one or more phenolic functions per molecule. The terms aliphatic, cycloaliphatic and aromatic, when used to describe phenols, refers to phenols to which aliphatic, cycloaliphatic and aromatic residues or combinations of these backbones are attached by direct bonding or ring fusion.

As used herein, “alkenyl,” “alkene” or “olefin” refers to straight or branched chain unsaturated hydrocarbyl groups having at least one carbon-carbon double bond, and having in the range of about 2 up to 500 carbon atoms. In certain embodiments, alkenyl groups have in the range of about 5 up to about 250 carbon atoms, 5 up to about 100 carbon atoms, 5 up to about 50 carbon atoms or 5 up to about 25 carbon atoms. In other embodiments, alkenyl groups have in the range of about 6 up to about 500 carbon atoms, 8 up to about 500 carbon atoms, 10 up to about 500 carbon atoms or 20 up to about 500 carbon atoms or 50 up to about 500 carbon atoms. In yet further embodiments, alkenyl groups have in the range of about 6 up to about 100 carbon atoms, 10 up to about 100 carbon atoms, 20 up to about 100 carbon atoms or 50 up to about 100 carbon atoms, while in other embodiments, alkenyl groups have in the range of about 6 up to about 50 carbon atoms, 6 up to about 25 carbon atoms, 10 up to about 50 carbon atoms, or 10 up to about 25 carbon atoms. “Substituted alkenyl” refers to alkenyl groups further bearing one or more substituents as set forth above.

As used herein, “alkylene” refers to a divalent alkyl moiety, and “oxyalkylene” refers to an alkylene moiety containing at least one oxygen atom instead of a methylene (CH₂) unit. “Substituted alkylene” and “substituted oxyalkylene” refer to alkylene and oxyalkylene groups further bearing one or more substituents as set forth above.

As used herein, “alkynyl” refers to straight or branched chain hydrocarbyl groups having at least one carbon-carbon triple bond, and having in the range of 2 up to about 100 carbon atoms, typically about 4 to about 50 carbon atoms, and frequently about 8 to about 25 carbon atoms. “Substituted alkynyl” refers to alkynyl groups further bearing one or more substituents as set forth below.

As used herein, “oxiranylene” refers to divalent moieties having the structure:

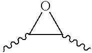

As used herein, “arylene” refers to a divalent aryl moiety. “Substituted arylene” refers to arylene moieties bearing one or more substituents as set forth above.

As used herein, “acyl” refers to alkyl-carbonyl species.

“Allyl” as used herein, refers to refers to a compound bearing at least one moiety having the structure:

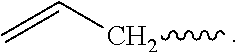

“Imide” as used herein, refers to a functional group having two carbonyl groups bound to a primary amine or ammonia. The general formula of an imide of the invention is:

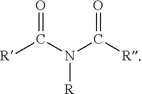

“Polyimides” are polymers of imide-containing monomers. Polyimides are typically linear or cyclic. Non-limiting examples of linear and cyclic (e.g. an aromatic heterocyclic polyimide) polyimides are shown below for illustrative purposes.

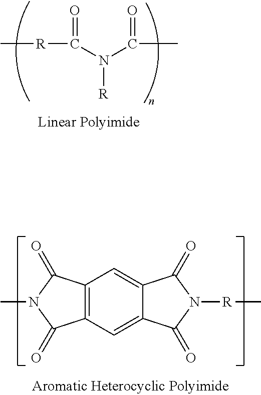

“Maleimide,” as used herein, refers to an N-substituted maleimide having the formula as shown below:

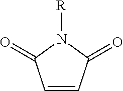

where R is an aromatic, heteroaromatic, aliphatic, or polymeric moiety.

“Bismaleimide” or “BMI”, as used herein, refers to compound in which two imide moieties are linked by a bridge, i.e. a compound a polyimide having the general structure shown below:

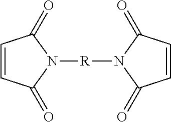

where R is an aromatic, heteroaromatic, aliphatic, or polymeric moiety.

BMIs can cure through an addition rather than a condensation reaction, thus avoiding problems resulting from the formation of volatiles. BMIs can be cured by a vinyl-type polymerization of a pre-polymer terminated with two maleimide groups.

As used herein, the term “acrylate” refers to a compound bearing at least one moiety having the structure:

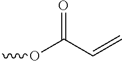

As used herein, the term “acrylamide” refers to a compound bearing at least one moiety having the structure:
Error! Objects cannot be created from editing field codes.

As used herein, the term “methacrylate” refers to a compound bearing at least one moiety having the structure:
Error! Objects cannot be created from editing field codes.

As used herein, the term “acrylonitrile” refers to a compound bearing at least one moiety having the structure:

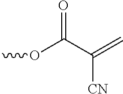

As used herein, the term “methacrylamide” refers to a compound bearing at least one moiety having the structure:

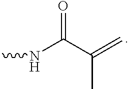

As used herein, “maleate” refers to a compound bearing at least one moiety having the structure:

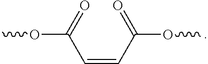

As used herein, the term “acyloxy benzoate” or “phenyl ester” refers to a compound bearing at least one moiety having the structure:

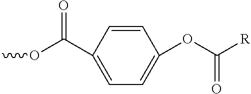

wherein R═H, lower alkyl, or aryl.

As used herein, the term “citraconimide” refers to a compound bearing at least one moiety having the structure:

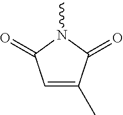

“Itaconate”, as used herein refers to a compound bearing at least one moiety having the structure:

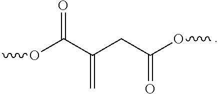

As used herein, the terms “halogen,” “halide,” or “halo” include fluorine, chlorine, bromine, and iodine.

As used herein, “siloxane” refers to any compound containing a Si—O moiety. Siloxanes may be either linear or cyclic. In certain embodiments, siloxanes of the invention include 2 or more repeating units of Si—O. Exemplary cyclic siloxanes include hexamethylcyclotrisiloxane, octamethylcyclotetrasiloxane, decamethylcyclopentasiloxane, dodecamethylcyclohexasiloxane and the like.

As used herein, “oxiranylene” or “epoxy” refers to divalent moieties having the structure:

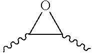

The term “epoxy” also refers to thermosetting epoxide polymers that cure by polymerization and crosslinking when mixed with a catalyzing agent or “hardener,” also referred to as a “curing agent” or “curative.” Epoxies of the present invention include, but are not limited to aliphatic, cycloaliphatic, glycidyl ether, glycidyl ester, glycidyl amine epoxies, and the like, and combinations thereof.

As used herein, the term “oxetane” refers to a compound bearing at least one moiety having the structure:

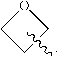

As used herein, the term “vinyl ether” refers to a compound bearing at least one moiety having the structure:

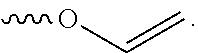

As used herein, the term “vinyl ester” refers to a compound bearing at least one moiety having the structure:

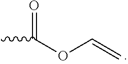

As used herein, “styrenic” refers to a compound bearing at least one moiety having the structure:

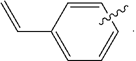

“Fumarate” as used herein, refers to a compound bearing at least one moiety having the structure:

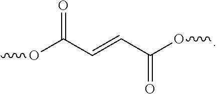

“Propargyl” as used herein, refers to a compound bearing at least one moiety having the structure:

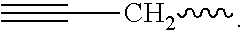

As used herein, “norbornyl” refers to a compound bearing at least one moiety having the structure:

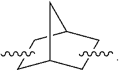

As used herein, a “primary amine terminated difunctional siloxane bridging group” refers to a moiety having the structural formula:

H₂N—(CR₂)ₘSi(R′)₂—O_{q}Si(R′)₂—(CR₂)ₙ—NH₂

where each R is H or Me, each R′ is independently H, lower alkyl, or aryl; each of m and n is an integer having the value between 1 to about 10, and q is an integer having the value between 1 and 100.

As used herein a “primary amine terminated polypropylene oxide” refers to a moiety having the structural formula:

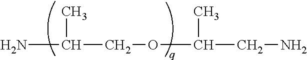

where q is 4 to about 50.

As used herein a “primary amine terminated butadiene acrylonitrile copolymer” refers to a moiety having the structural formula:

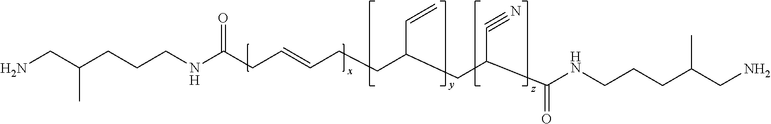

where each x and y are independently 0 to about 20; x plus y is about 10 to about 20, and z is about 1 to 5.

As used herein, the term “free radical initiator” refers to any chemical species which, upon exposure to sufficient energy (e.g., light, heat, or the like), decomposes into parts, which are uncharged, but every one of such part possesses at least one unpaired electron.

As used herein, the term “coupling agent” refers to chemical species that are capable of bonding to a mineral surface and which also contain polymerizably reactive functional group(s) so as to enable interaction with the adhesive composition. Coupling agents thus facilitate linkage of the die-attach paste to the substrate to which it is applied.

“Diamine,” as used herein, refers generally to a compound or mixture of compounds, where each species has 2 amine groups.

“Glass transition temperature” or “T_{g}”: is used herein to refer to the temperature at which an amorphous solid, such as a polymer, becomes brittle on cooling, or soft on heating. More specifically, it defines a pseudo second order phase transition in which a supercooled melt yields, on cooling, a glassy structure and properties similar to those of crystalline materials e.g. of an isotropic solid material.

“Modulus” or “Young's modulus” as used herein, is a measure of the stiffness of a material. Within the limits of elasticity, modulus is the ratio of the linear stress to the linear strain, which can be determined from the slope of a stress-strain curve created during tensile testing.

The “Coefficient of Thermal Expansion” or “CTE” is a term of art describing a thermodynamic property of a substance. The CTE relates a change in temperature to the change in a material's linear dimensions. As used herein “α₁ CTE” or “α₁” refers to the CTE before the T_{g}, while “α₂ CTE” refers to the CTE after the T_{g}.

“Thixotropy” as used herein, refers to the property of a material which enables it to stiffen or thicken in a relatively short time upon standing, but upon agitation or manipulation to change to low-viscosity fluid; the longer the fluid undergoes shear stress, the lower its viscosity. Thixotropic materials are therefore gel-like at rest but fluid when agitated and have high static shear strength and low dynamic shear strength, at the same time.

“Thermogravimetric analysis” or “TGA” refers to a method of testing and analyzing a material to determine changes in weight of a sample that is being heated in relation to change in temperature. “Decomposition onset” refers to a temperature when the loss of weight in response to the increase of the temperature indicates that the sample is beginning to degrade.

### EMBODIMENTS OF THE INVENTION

In one embodiment the present invention provides for a method for producing maleimide-terminated polyimides and forming thermally stable compositions, in another embodiment of the invention the maleimide-terminated polyimide compounds can be mixed with a variety of other diluents to form an adhesive composition, in yet another embodiment of the invention a method is provided for preparing low dielectric and low dissipation factor film adhesive compositions, in yet another embodiment of the invention a coating or film of very low dielectric constant and dissipation factor for high power electronic devices, multiplayer capacitors, flexible copper clad laminates, interconnects, conformal coatings, die-attach pastes and films, as binders for cathode and anode powders for use in lithium-ion batteries, and as coatings for high power cables is provided for in the invention.

U.S. Pat. No. 7,884,174 B2, and U.S. Pat. No. 7,157,587 B2 (Mizori et al), and incorporated herein by reference discuss the synthesis and properties of imide-extended maleimide. The discovery of imide extended maleimide compounds in the liquid form or as low melting solids has enabled the formulator to use these compounds as additives in a variety of formulations to impart toughness, high temperature resistance, and hydrolysis resistance. The imide extended maleimide compounds can be represented according to the following Formula A.

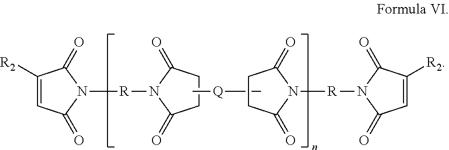

### Imide-Extended Maleimide Resin

wherein, R and Q are each independently substituted or unsubstituted aliphatic, alkenyl, aromatic, heteroaromatic, or siloxane moiety;

R₂ is H or methyl; and n is 1 to about 10.

The maleimide terminated polyimide compounds have certain advantageous properties, including; low modulus, very low moisture uptake, very high temperature resistance, low dielectric constant and low dielectric dissipation factor. The dielectric constant was measured at approximately 2.5, and the dissipation factor was measured at approximately 0.08. With the right additives we feel that the properties can be made even better so that the materials can find use in a wider array of applications.

The maleimide-terminated polyimides are low to high modulus, high temperature stable, hydrophobic liquids and films, with low dielectric constant and low dissipation factor. In certain applications some improvements are required to enhance the properties. In certain applications a higher glass transition temperature and lower coefficient of thermal expansion are required. In certain other applications the dielectric constant and dissipation factor need to be even lower. Flammability is always a very important issue in electronics applications, and additives are often added to keep flammability low.

The maleated polyethylene and polypropylene, and oxidized (carboxyl functionalized) polyethylene are available in several different molecular weight ranges as shown in Formulae VII-IX:

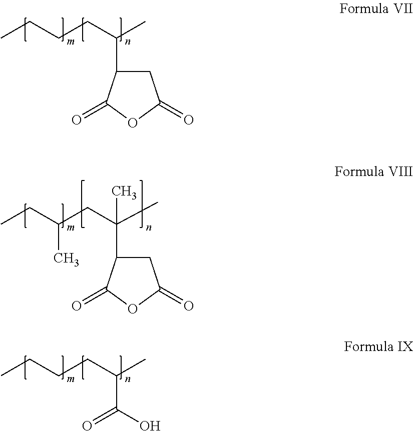

wherein m is an interger between about 50-1000, and

the n value for should be 1-10.

One skilled in the art can use a large number of synthetic chemistry techniques to convert these starting materials into a variety of curable oligomers. The following generic structures represent the compounds derived from the maleic anhydride grafted polyethylene:

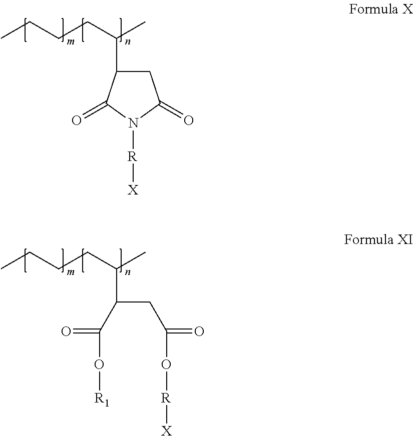

or the derivatives of maleic anhydride grafted polypropylene according to the following generic structure:

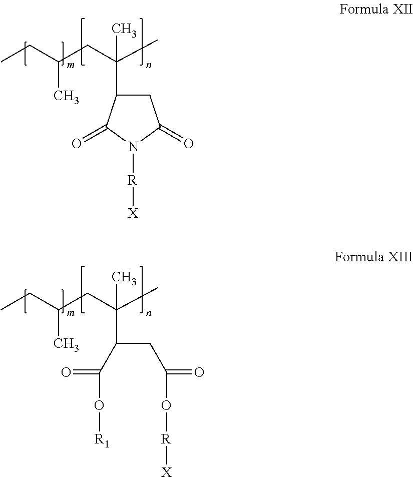

or the oxidized polyethylene derivatives according to the following generic structure:

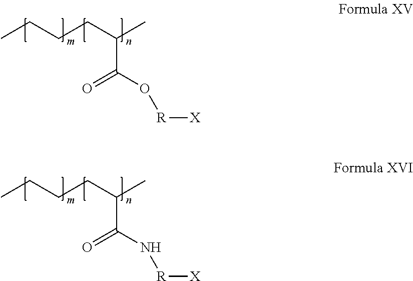

wherein

R₁ is H, methyl, alkyl, alkenyl, cycloalkenyl, cycloalkyl, heterocyclic, aryl, or heteroaryl,

R is independently substituted or unsubstituted aliphatic, aromatic, heteroaromatic, siloxane, unsaturated hydrocarbon, polyester, polyamide, or polyurethane moieties;

the value of m is an interger from 50-1000; and

the value of n is an interger from 1-10.

In certain embodiments, R can further include alkyl, alkenyl, alkynyl, hydroxy, oxo, alkoxy, mercapto, cycloalkyl, substituted cycloalkyl, heterocyclic, substituted heterocyclic, aryl, substituted aryl, heteroaryl, substituted heteroaryl, aryloxy, substituted aryloxy, halogen, haloalkyl, cyano, nitro, nitrone, amino, amido, —C(O)H, —C(O)—, —S—, —S(O)2-, —OC(O)—O—, —NR—C(O)—, —NR—C(O)—NR—, —OC(O)—NR—.

In certain aspects, R is H or lower alkyl, acyl, oxyacyl, carboxyl, carbamate, sulfonyl, sulfonamide, sulfuryl, and the like, and X is a polymerizable or curative moiety.

In some embodiments, the polymerizable moiety is a cationic polymerizable moiety, an anionic polymerizable moiety, a ring-opening polymerizable moiety, or a free radical polymerizable moiety. In some embodiments, the polymerizable moiety is vinyl ether, vinyl ester, acrylate, methacrylate, acrylamide, methacrylamide, maleate, fumarate, epoxy, oxetane, oxazoline, benzoxazine, prorpargylether, vinyl chloride, urethane, norbomyl, maleimide, or nadimide. In some embodiments the curative is phenol, phenyl ester and the like, in yet another embodiment the curative is a mercapto derivative.

The curable oligomers of the invention include, but are not limited to the following compounds:

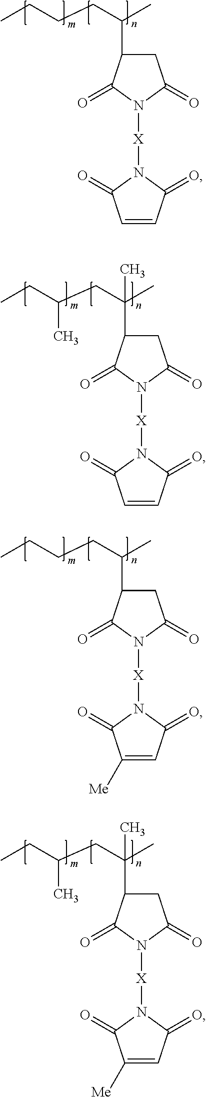

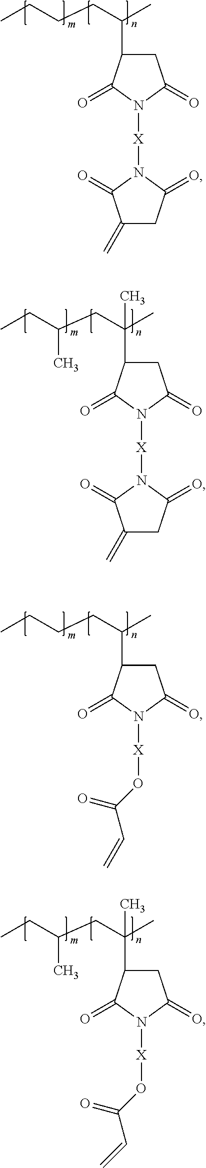

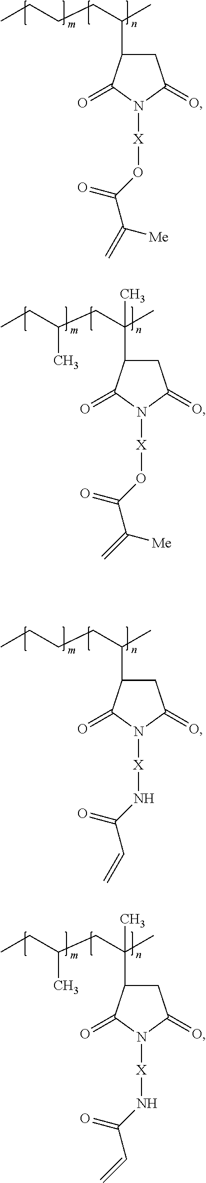

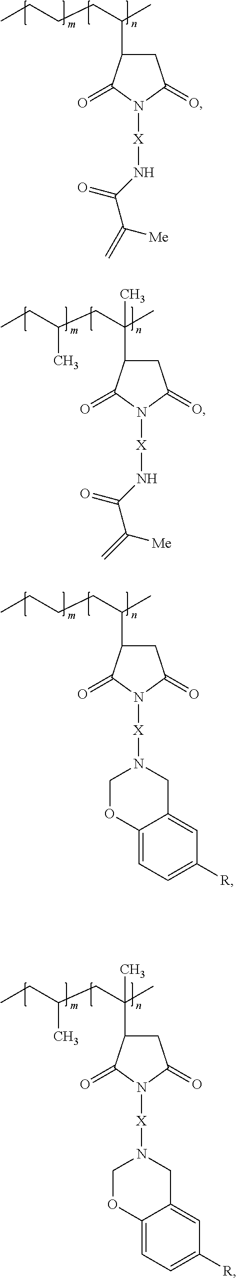

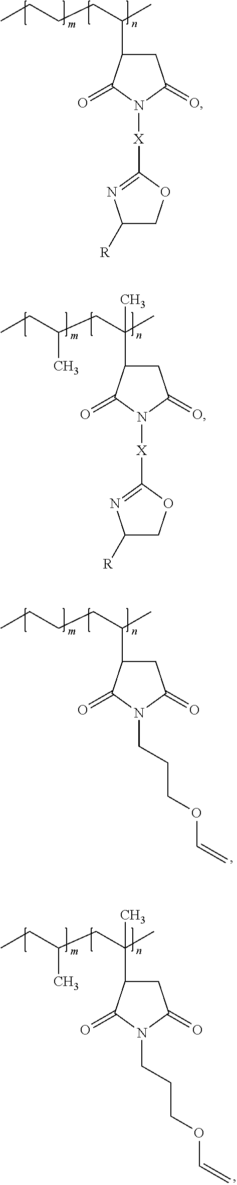

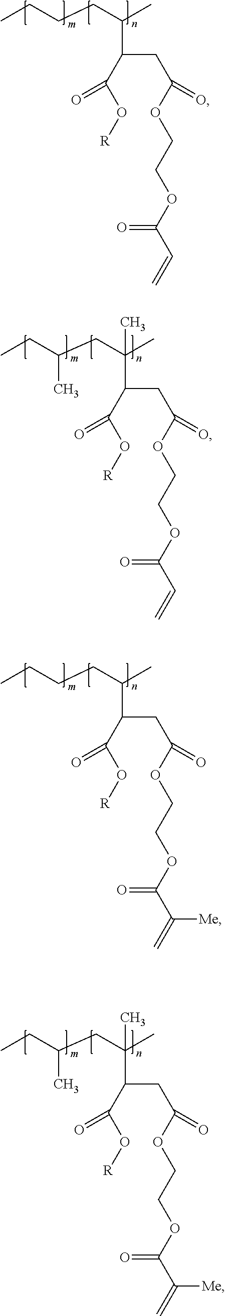

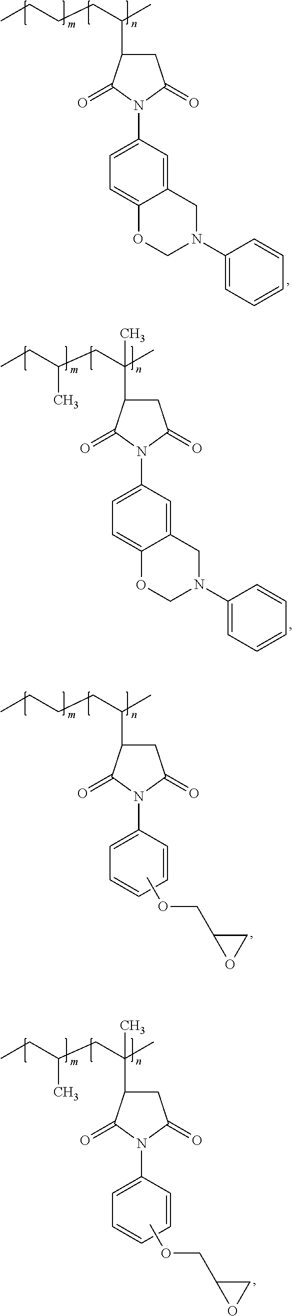

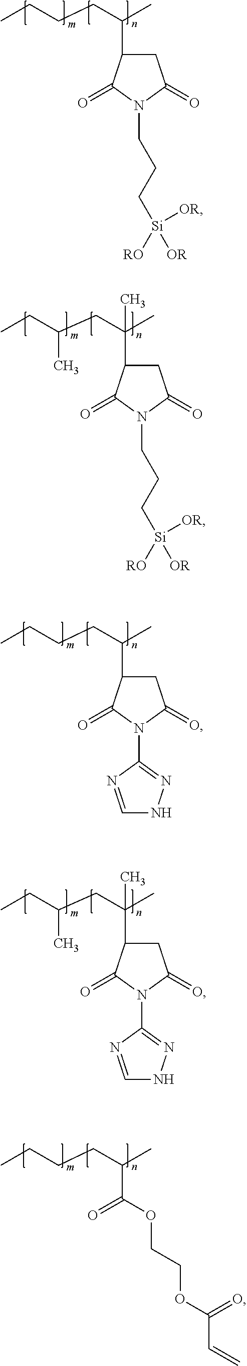

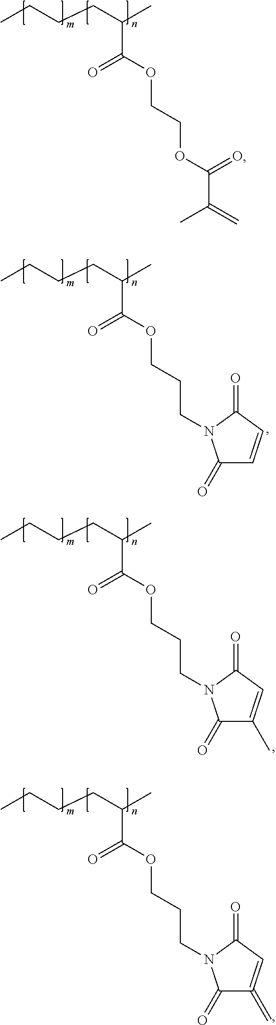

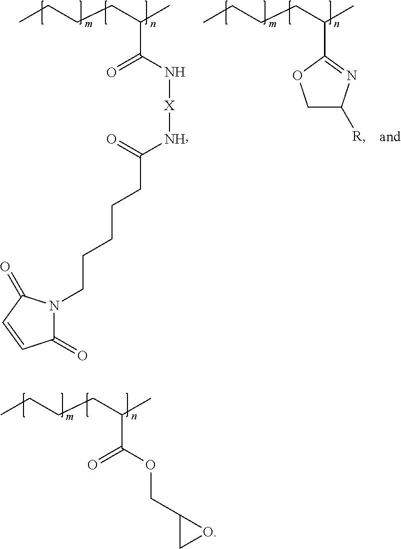

wherein

the value of m is an interger from 50-1000; and

the value of n is an interger from 1-10.

The polyethylene and polypropylene compounds of the invention have been synthesized to include a variety of functional groups, including but not limited to maleimides, citraconimides, acrylates, methacrylates, acrylamides, methacrylamides, benzoxazines, oxazolines, phenolics, epoxies, silanes, vinyl ethers and other compounds known to those skilled in the art.

Fluoropolymers are compounds known to have some of the lowest dielectric constants and dissipations factors. The problem with these materials is that it is very difficult to get these compounds to stick to anything. The dielectric constant of polytetrafluoroethylene (Teflon) is approximately 2.1 and the dissipation factor is approximately 0.0002 over a wide frequency range. The glass transition temperature (TO of PTFE is approximately 115° C., and the coefficient of thermal expansion (CTE) is approximately 120. PTFE also has a very good flammability rating it is self-extinguishing material.

The maleimide-terminated polyimides of the invention have very low surface energy and are very compatible with PTFE. In fact malemide-terminated polyimides will wet PTFE, therefore, PTFE can be used as a filler in many compositions to enhance the properties.

A wide variety of perfluorinated hydrocarbon polymers can be employed for the preparation of invention compositions. Many such materials are available commercially, for example, from DuPont under the tradename Teflon or from Hoechst-Celanese under the tradename Hostafalon®. Exemplary perfluorinated hydrocarbon polymers contemplated for use in accordance with the present invention are typically characterized as having a particle size in the range of about 0.1 up to about 100 microns, a surface area in the range of about 0.2 up to about 20 g/m², and a bulk density of at least 100 g/L.

In certain embodiments, the perfluorinated hydrocarbon polymers employed in the practice of the present invention are characterized as having an average bulk density in the range of about 250-500 g/L, a melting peak temperature (as determined by ASTM D1457) of 325.+−0.5.degree. C., average particles size distribution in the range of about 8-15 microns, a specific surface area in the range of about 8-12 g/m², and a relatively narrow molecular weight distribution.

The quantity of perfluorinated hydrocarbon polymer employed in the practice of the present invention can vary within wide ranges, typically falling in the range of about 5 up to about 75 weight percent of invention composition; typically in the range of about 10 up to about 50 wt. percent (based on the total weight of the final composition).

As readily recognized by those of skill in the art, a wide variety of additional components can optionally be incorporated into the above-described formulation, such as, for example, coupling agents, anti-oxidants, stabilizers, bleed control agents, additional fillers (other than the required perfluorinated hydrocarbon polymer), inert diluents, reactive diluents, adhesion promoters, flexibilizers, dyes, pigments, and the like.

Polyhedral Oligomeric Silsesquioxanes (POSS), are caged silicones with various functionality. These nanocomposites have advantageous properties such as lowering the melt viscosity and flow of various polymers. The caged structure also has a great deal of free volume. Since air or vacuum (e.g. free volume of the caged structure) has the lowest dielectric constant (1.0), the addition of these materials to maleimide-terminated polyamide resins will lower the dielectric constant of resin compositions containing them. The addition of POSS nanoparticles also increases the T_{g} and lower the CTE of certain formulations of the invention maleimide-terminated polyimide compositions. The POSS nanoparticles also have a very good flammability rating and will enhance the flammability rating of the maleimide-terminated polyamide resin. The POSS materials contemplated for use in the practice of the invention include, but are not limited to the following, and combinations thereof:

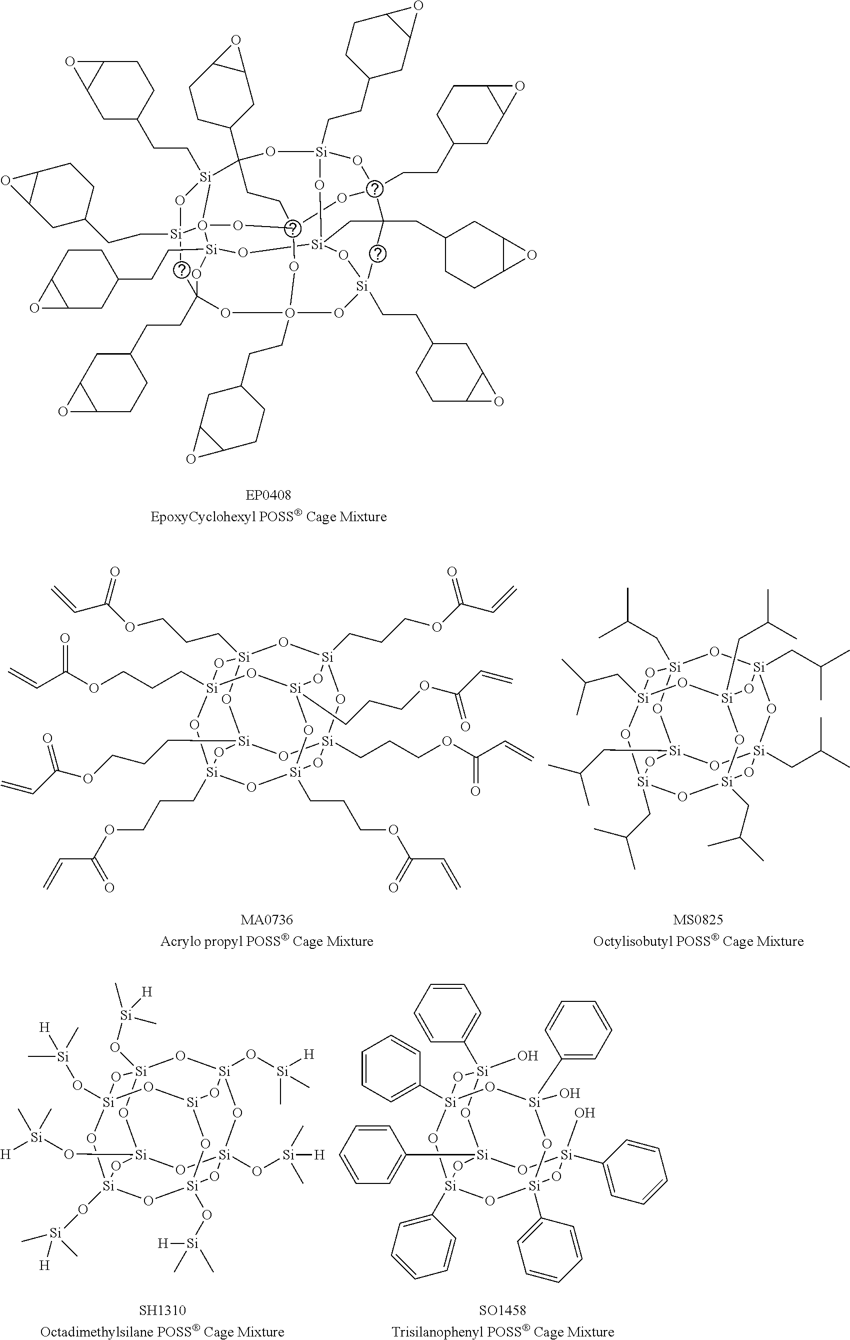

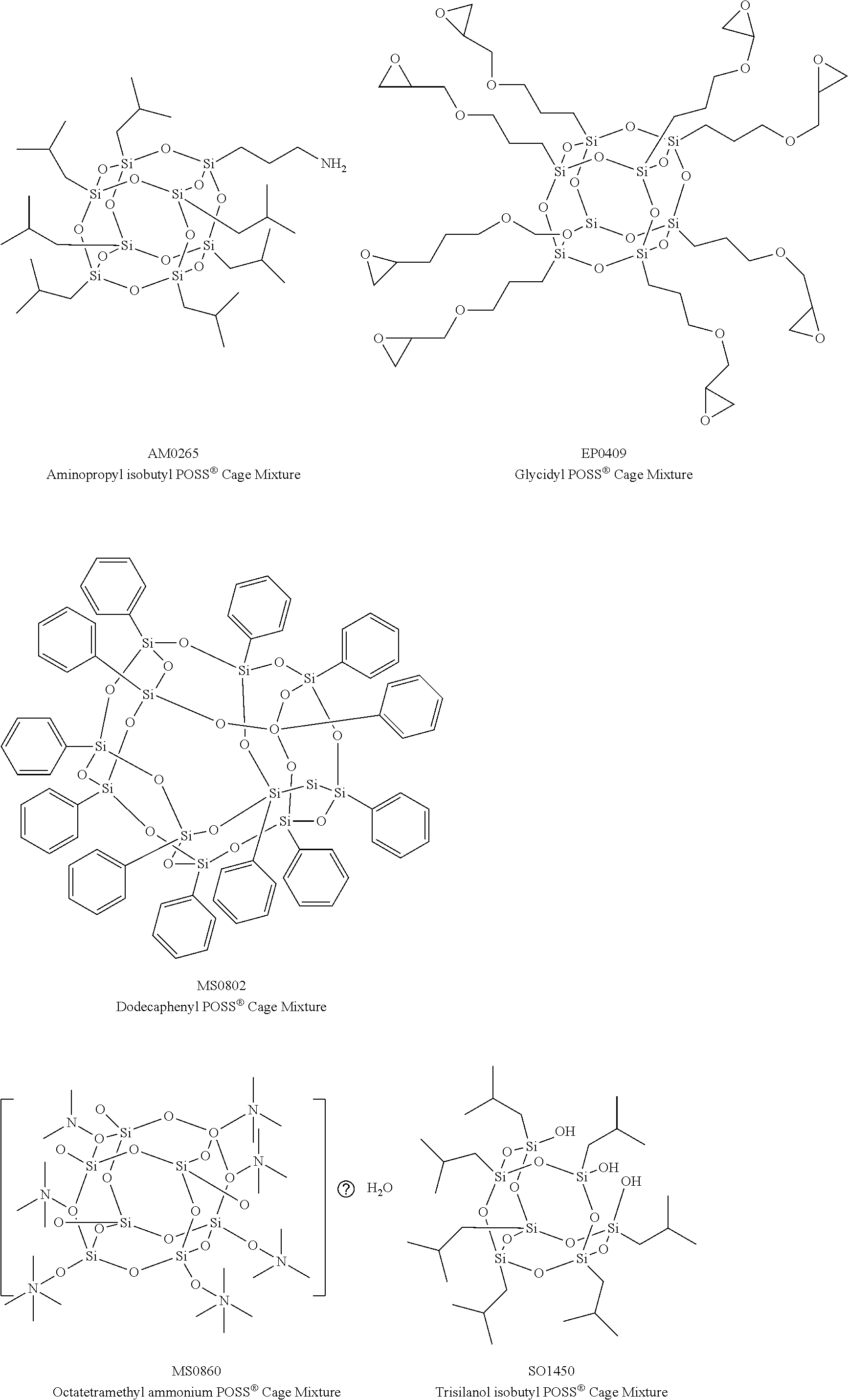

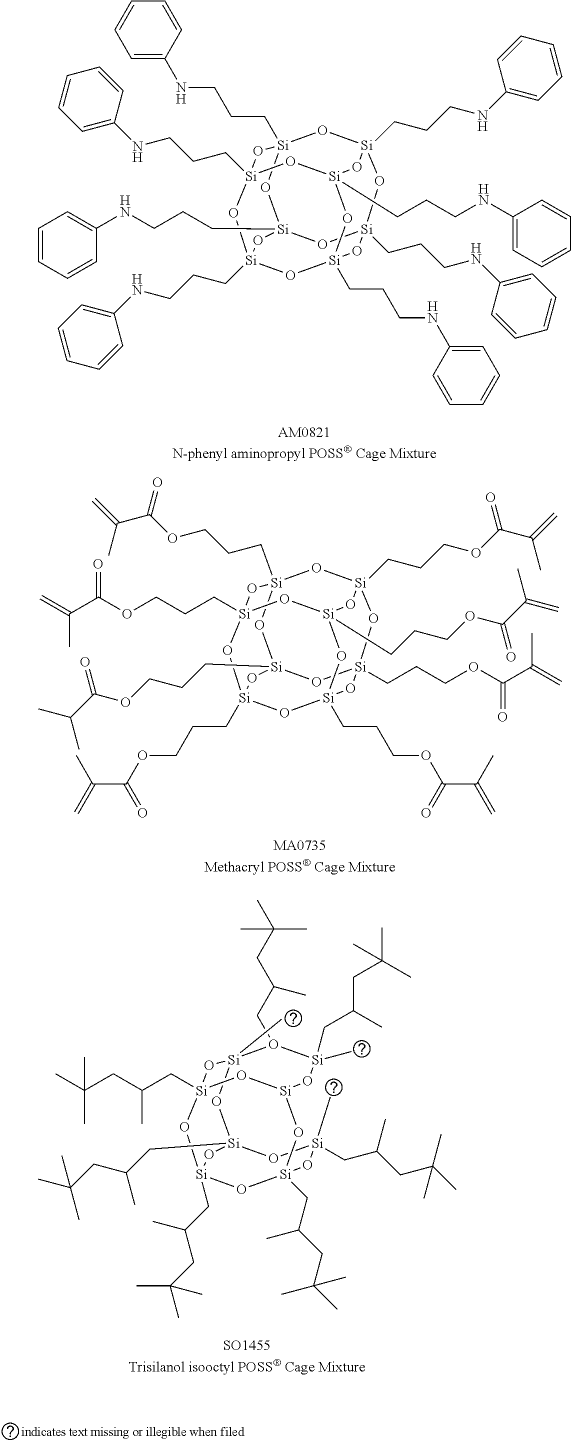

The POSS materials listed above are available from Hybrid Plastics, (Hattiesburg, Miss.). A wide variety of POSS materials (e.g., nanoparticles), are available from Hybrid Plastics, and other vendors. These caged compounds can include non-reactive moieties and/or can include one or multi-reactive groups on the perimeter. The reactive groups include maleimides, (meth)acrylates, cyanate esters, epoxies, thiols, amines, phenolics and the like. The entire range of POSS materials are contemplated for use in the invention. Furthermore, the POSS nanoparticles can be reacted further to produce functionalized materials that are more compatible with the type of maleimide-terminated polyimide for specific applications.

The quantity of POSS employed in the practice of the present invention can vary within wide ranges, typically falling in the range of about 2 up to about 50 wt. percent of invention compositions; typically in the range of about 5 up to about 25 wt. percent (based on the total weight of the final composition).

The maleimide-terminated polyimide compounds of the invention are capable of undergoing homopolymerization along with an appropriate catalyst. The catalysts contemplated for use in curing these compounds include but are not limited to free-radical catalyst such as peroxides and hydroperoxides, and also many compounds that form free radical upon UV exposure. The amount of free-radical catalyst contemplated for use in the practice of the invention is between about 0.01 and about 5.0% by weight, based on the total weight of the composition. Also contemplated for use are free radical decomposers such as certain metals and metal salts such as iron, zinc, copper, tin, nickel and other transition metal salts known to those skilled in the art to cause decomposition of hydroperoxides.

Certain compounds of the invention are capable of undergoing polymerization via cationic means. Cationic polymerization catalysts contemplated for use in the practice of the invention include but are not limited to protic acids, Lewis acids, quaternary ammonium salts, phosphoric acid derivatives, organoboranes, organoaluminum compounds, certain tin complexes, zinc complexes, certain UV sensitive cationic catalysts. Some of the compounds of the invention are capable of undergoing polymerization via anionic means. Anionic catalysts contemplated for use in the invention include but are not limited to certain amines, imidazoles, strong bases, and ECAT catalyst (equilibrium fluid catalytic cracking (FCC) catalyst), such as the imidazole epoxy catalysts available from Designer Molecules, Inc., San Diego, Calif. (e.g., ECAT-259 (modified imidazole (1,3-Benzenediol, 4-[1-[[3-(1H-imidazol-1-yl)propyl]imino]ethyl]-; CAS No. 1313999-39-1); ECAT-353 (modified imidazole (1,3-Benzenediol, 4,4′-[[3-(1H-imidazol-1-yl)propyl]carbonimidoyl]bis- :CAS No. 1325729-75-6); ECAT-243 (modified imidazole; CAS No. 1253404-90-8); ECAT-434 (modified imidazole). The catalyst used to cure the invention compounds can be added in an amount from about 0.01% by weight up to about 10% by weight based on the total weight of the formulation.

Since the invention formulations include free-radically curable materials, in certain embodiments of the invention, the formulations will also include free-radical inhibitors. The addition of free-radical inhibitors helps to extend the product's shelf life and prevent premature curing. Many free-radical inhibitors are known as antioxidants. These compounds include reducing agents such as thiols, ascorbic acid and polyphenols. In the laboratory, phenolic compounds such as butylated hydroxytolune (BHT) and methoxyhydroquinone (MEHQ), hydroquinone (HQ), are frequently added to formulations according to the present invention. The combination of a phenolic inhibitor with benzoquinone derivatives has a synergistic effect and is more potent as an inhibitor than individual compounds. The addition of certain nitrosyl compounds, certain tertiary amines, nitro-aromatic compounds are known to those skilled in the art to prevent premature free-radical curing of compositions and to provide good shelf-life to products.

In embodiments of the invention, additives such as adhesion promoters and coupling agents may be included in formulations that are used as coatings or adhesives. Adhesion promoters for copper surfaces include amine functionalized silane coupling agents, in combination with acidic coupling agents such as anhydride functionalized materials. Various silane coupling agents are also contemplated for use in the practice of the invention, when certain surfaces to be bonded are used.

Fire retardants contemplated for use in the invention include but are not limited to: aluminum hydroxide; high temperature stable magnesium hydroxide; borates; melamine derivatives; and organophosphates. Halogenated hydrocarbons are very effective flame retardants, however, their use is very limited since these compounds would cause reliability problems in microelectronics uses. Furthermore, halogenated hydrocarbons are considered to by environmental pollutants and their use is therefore disfavored. Fire retardants contemplated for use in the composition of the invention have high dielectric constants and high dielectric dissipation factors. Thus, these materials (especially the inorganic materials) cannot be used in very high quantities, otherwise the desirable properties of the invention compositions may be lost.

Even at small concentration (5-10% by weight), the addition of Teflon and or POSS to the invention formulations causes the formulations to become less flammable. The addition of these compounds will also lower the dielectric constant and dielectric dissipation factor of the coating, film or adhesive. Thus, in certain embodiments of the invention, such fire retardants can be included in invention compositions in small quantities (5-10% by weight) to reduce flammability without destroying the good properties.

The maleimide-terminated polyimides compounds of the invention form good cured products when homocured with an appropriate curing agent. However, there is only a small amount of functional group in the molecule; therefore, the cured films often need to be toughened by co-curing with more rigid or higher cross-link density monomers. Monomers compatible with the free-radically curable maleimide-terminated polyimide compounds of the invention include but are not limited to mono-, di-, and polyfunctional meth(acrylates), found in various catalogs; bismaleimides of versamine-551 and the bismaleimide of versamine-552; various meth(acrylates) based on dimer diol and dimer acid; functionalized urethanes based on DDI-1410, and various aliphatic isocyanates; meth(acrylates) based on saturated or unsaturated polybutadienes, various vinyl ethers dilutents, acrylamide and methacrylamide resins, itaconates, fumarates, maleates and the like.

Furthermore, specifically the maleimide-terminated polyimides of the invention can be combined with various dienes, allylic compounds, vinyl compounds, benzocyclobutene derivatives, styrenic compounds, and α-methyl styrenic compounds at high temperature to produce composites. The composition-forming reaction occurs via Diels-Alder reaction to form very rigid high temperature stable materials for various applications such as aircraft assembly, marine craft assembly, auto part assembly, wind turbine assembly and composite pipes. Examples of compounds that work well for forming rigid, temperature stable composites include diallyl bisphenols-A, benzocyclobutenes, and α-methyl styrene derivatives.

Furthermore, curable functionalized polyethylene, polypropylene, polybutadiene materials have been shown to have very low dielectric constants and very low dissipation factors. All of these compounds are also contemplated for use with the maleimide-terminated polyimides in the compositions of the invention along with the perfluorinated hydrocarbons and POSS nanoparticles. Combinations of all of the above are contemplated for use in the practice of the invention.

When cured the maleimide-terminated polyimides of the invention produce very tough films that are very hydrophobic, low modulus, with low dielectric constant, and low dielectric dissipation factor. These properties, particularly dielectric constant and dissipation factor, are enhanced when fluorinated hydrocarbon fillers and POSS nanoparticles, are included in the compositions of the invention. The additional benefit is gained in that the flammability rating of the maleimide-terminated polyimide formulations is much improved.

In addition to free-radically curable additives, a wide range of epoxy resins are contemplated for use in the invention, these include but are not limited by examples such as bisphenol-A diglycidyl ether, bisphenol-F diglycidyl ether, Epon resins, glycidyl ester resins based on aliphatic di-, and polycarboxylic acids, and the like. These compounds can form hybrid cure systems that can enhance the properties of the composition as well as increasing the adhesion of the composition to various substrates.

The combination of maleimide-terminated polyimides with perfluorinated hydrocarbons, POSS nanoparticles, and additives described herein can be used in a variety of applications. These applications include but are not limited to all areas of electronics packaging applications, flexible copper clad laminates, composite packaging, lithium-ion batteries construction, fuel cells and their construction, conformal coatings applications, die-attach pastes and film applications. Furthermore, the invention compositions are very thermally stable, have very low moisture uptake and are very good chemical resistance. These materials in combination with perfluorinated hydrocarbons and POSS nanoparticles can have use in down-hole oil exploration field as protective coatings for sensitive equipment and as lining for pipes. In marine environments where hydrophobic low drag materials are required for coatings and adhesives these materials would be ideal. The materials in combination with various dienes and allylic compounds can produce very good composites useful in aircraft assembly, pipe assembly, auto parts assembly, marine craft assembly, wind turbine assembly and the like.

### EXAMPLES

### Example 1

### Synthesis of Compound I (BMI-3000)

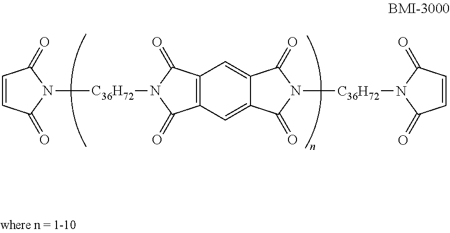

A 1-L reaction flask equipped with Teflon-coated stir bar was charged with 164.7 g (300 mmol) of (Priamine™ 1075 (dimer diamine; EC Reg. No. 273-282-8; Croda Coatings & Polymers, East Yorkshire, UK). To the reaction flask was added 200 g of N-methylpyrrolidone (NMP) and 500 g of toluene, followed by the addition of 25 g of methanesulfonic acid. The mixture was stirred vigorously, while 43.6 g (200 mmol) of pyromellitic dianhydride was added to the flask. The polyamic acid solution was heated to reflux and the water generated in the reaction was removed using a Dean-Stark trap over 6 hours. The solution was cooled down and 23.5 g (240 mmol) of maleic anhydride was added to the flask. The solution was heated back to reflux overnight. After 18 hours the remaining water was collected in the Dean-Stark trap signaling the end of the reaction. The solution was diluted with an additional 500 g of toluene and placed in a separatory funnel. The solution was washed with 200 g of water, followed by two 100 g brine washes to remove the NMP and acid. The bulk of the toluene was removed under vacuum to obtain an approximately 50% by weight solids solution. The product was collected by precipitation of the material into stirred methanol. The solid was solid resin was collected by filtering through a Buchner funnel, followed by drying in the oven.

### Example 2

### Synthesis of Compound II (BMI-2192)

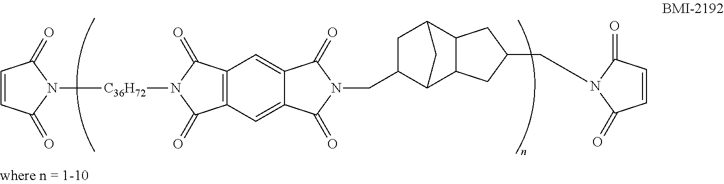

A 1-L reaction flask equipped with Teflon-coated stir bar was charged with 109.8 g (200 mmol) of Priamine-1075, and 38.8 g (200 mmol) of Bis(aminomethyl)tricyclodecane. To the reaction flask was added 200 g of NMP and 500 g of toluene, followed by the addition of 25 g of methanesulfonic acid. The mixture was stirred vigorously, while 65.4 g (300 mmol) of pyromellitic dianhydride was added to the flask. The polyamic acid solution was heated to reflux and the water generated in the reaction was removed using a Dean-Stark trap over 6 hours. The solution was cooled down and 23.5 g (240 mmol) of maleic anhydride was added to the flask. The solution was heated back to reflux overnight. After 18 hours the remaining water was collected in the Dean-Stark trap signaling the end of the reaction. The solution was diluted with an additional 500 g of toluene and placed in a separatory funnel. The solution was washed with 200 g of water, followed by two 100 g brine washes to remove the NMP and acid. The bulk of the toluene was removed under vacuum to obtain an approximately 50% by weight solids solution. The product was collected by precipitation of the material into stirred acetone. The solid was solid resin was collected by filtering through a Buchner funnel, followed by drying in the oven.

### Example 3

### Synthesis of Compound III (Maleimide Maleic Anhydride-Graft Polyethylene)

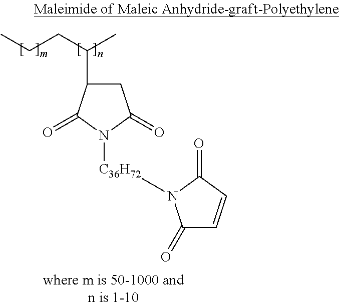

A 1-L reaction flask equipped with Teflon-coated stir bar was charged with 100 g of maleic anhydride grafted polyethylene (M.W. ˜9000). The powder was dissolved in 300 mL of toluene along with 100 mL of NMP. A large excess (54.0 g, 100 mmol) of Versamine-552 (dimer diamine; C₃₆ alkylenediamine or (12E,15E)-N-[(21E,24E)-hexatriaconta-21,24-dienyl]-1-hexatriaconta-12,15-dienamine; CAS No. 38955-56-6; Cognis; Monheim, Germany) (54.0 g, 100 mmol) was added to the stirred solution. The solution was heated to reflux, and the condensed water was collected in a Dien-Stark trap over about 3 hours. The solution was allowed to cool down to room temperature and then 19.6 g (200 mmol) of maleic anhydride was added to the stirred solution, along with 10 g of methanesulfonic acid. The solution was allowed to reflux 16 hours to collect produce the maleimide-functionalized polyethylene. The solution was allowed to cool down to room temperature and 50 g of sodium bicarbonate was added and stirred for 1 hour to neutralize the acid. The material was diluted further with 200 ml of toluene and filtered through paper filter. The product was obtained by precipitation in a large excess of acetone. After drying a white powder was obtained, Fourier transform infrared spectroscopy (FTIR) analysis indicated the presence of maleimide group on the molecule.

### Example 4

### Synthesis of Compound IV (Maleimide-Ester of Oxidized Polyethylene)

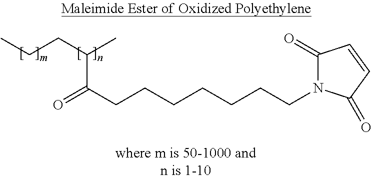

A 1-L reaction flask equipped with a Teflon-coated stir bar was charged with 100 g of oxidized polyethylene (M.W. ˜3600). The material was dissolved in 300 mL of toluene. To the flask was added a large excess of a previously prepared maleimido-propanol solution in toluene and NMP. Approximately 10 g of methanesulfonic acid was added to the flask, and the solution was heated to reflux. The condensed water was collected in a Dien-Stark trap over a period of 3-4 hours. The solution was allowed to cool down to room temperature and the product was collected by precipitation in a large excess of methanol and water. The powder was continuously washed with methanol to get out all of the acid and NMP, followed by drying in the oven at 40° C. for several hours. A slightly yellow powder was collected after drying.

### Example 5

### Permittivity and Loss Tangent

Thin films were made of various materials with additives to test for dielectric constant (permittivity), and dielectric dissipation factor (loss tangent). The main resin in these films is the maleimide-terminated polyamide, which was mixed with polyethylene derivative, Teflon or POSS material in a high boiling solvent (e.g., tetralin; 1,2,3,4-tetrahydronaphthalene). The POSS did not have any trouble blending in with the polyamide resin, but in the case of the functionalized polyethylene and Teflon the best way to get the materials to make intimate contact was to pass the mixture through a three-roll mill several times to get them fully blended, followed by the addition of solvent and 2% dicumyl peroxide curing initiator.

A small amount of the mixture is then placed in a 2×2 inch shallow mold and into an oven at 100° C. to drive off the solvent for several hours. After all of the solvent has been driven off the top of the mold is covered to prevent oxygen inhibition of the surface. The temperature is slowly raised to 175° C. and held for 3 hours to fully cure the resin. The films are removed from the mold and are approximately 40 mils (1 mm) thick to be sent out for analysis.

The permittivity and loss tangent were determined by using a Hewlett Packard Impedance Material Analyzer. The permittivity and loss tangent were determined at 1 GHz frequency and the results are recorded in Table 1, below.

TABLE 1
Permittivity and Loss Tangent Data

| | AVERAGE | AVERAGE |
|---|---|---|
| | PERMITTIVITY | LOSS TANGENT |
| SAMPLE | 1 GHz | 1 GHz |
| Compound I (BMI-3000 | 2.5 | 0.003 |
| Compound I (BMI-3000) + | 2.4 | 0.002 |
| 25% maleimide ester of | | |
| Polyethylene | | |
| Compound I (BMI-3000) + | 2.54 | 0.002 |
| 15% Teflon | | |
| Compound I (BMI-3000) + | 2.51 | 0.004 |
| 5% POSS MA0735 | | |
| Compound II (BMI-2192) | 2.66 | 0.005 |

1-52. (canceled)

53. A curable composition comprising,
a) at least one low dielectric constant, low dissipation factor resin; and
b) at least one compound selected from the group consisting of: adhesion promoters, cure catalysts, inhibitors, fillers, fire retardants, and reactive diluents.
wherein the at least one low dielectric constant, low dissipation factor resin:
i) comprises a compound of Formula II: 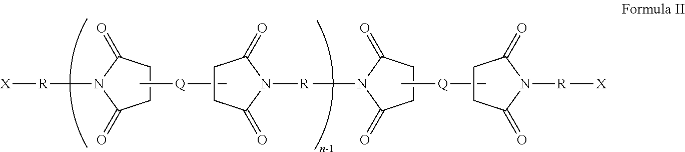
wherein each of R and Q is independently a substituted or an unsubstituted aliphatic, alkenyl, aromatic, heteroaromatic, or siloxane moiety; and X is a polymerizable moiety; or
ii) is a maleimide-terminated polyimide selected from the group consisting of: 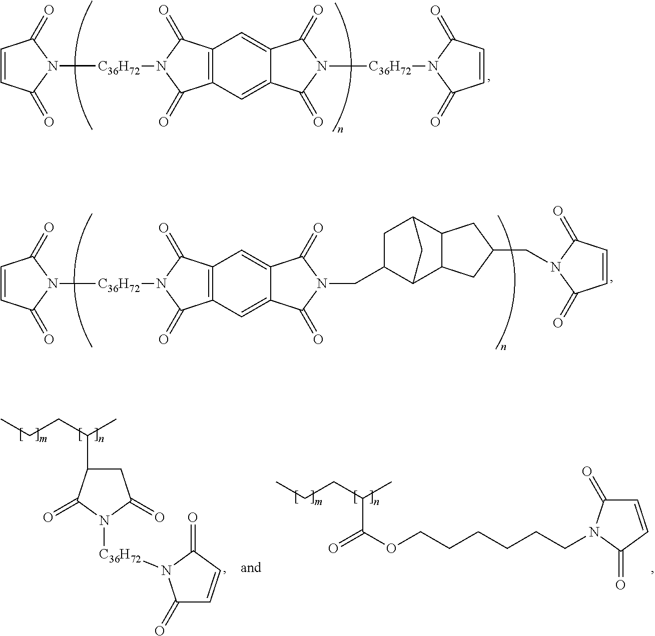
wherein
the value of m is an interger from 50-1000; and
the value of n is an interger from 1-10; or
iii) has a formula selected from the group consisting of Formulae I, III, IV and VI: 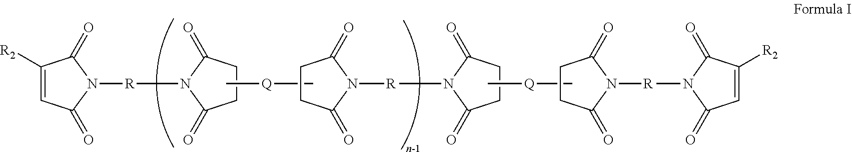
where each of R and Q is independently a substituted or an unsubstituted aliphatic, alkenyl, aromatic, heteroaromatic, or siloxane moiety; R₂ is H or methyl; and n is an integer having the value between 1 and about 10; 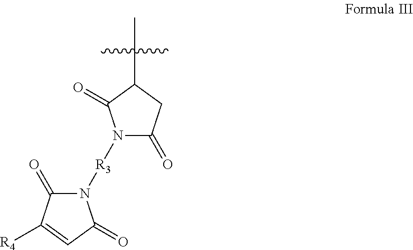
wherein:
R₃ is selected from the group consisting of a substituted or an unsubstituted aliphatic, alkenyl moiety having between 2 and 500 carbon atoms, aromatic, heteroaromatic and siloxane moieties; and
R₄ is selected from the group consisting of H and methyl; 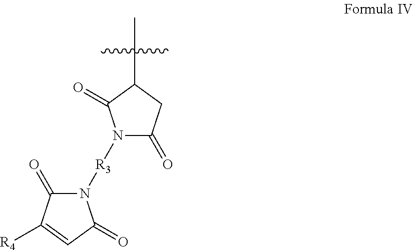
wherein:
R₃ is selected from the group consisting of a substituted or an unsubstituted aliphatic, alkenyl moiety having between 2 and 500 carbon atoms, aromatic, heteroaromatic and siloxane moieties; and
R₄ is selected from the group consisting of H and methyl; 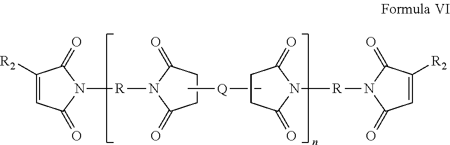
wherein, R and Q are each independently substituted or unsubstituted aliphatic, alkenyl, aromatic, heteroaromatic, or siloxane moiety;
R₂ is H or methyl; and n is 1 to about 10; or
iv) is a polymaleimide polymer comprising a plurality of repeating units having the structure: 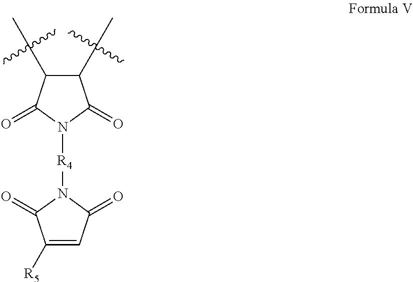
wherein:
R₄ is selected from the group consisting of a substituted or an unsubstituted aliphatic, alkenyl moiety having between 2 and about 500 carbon atoms, aromatic, heteroaromatic, or siloxane moieties; and
R₅ is selected from the group consisting of H and methyl.

54. The composition of claim 53, wherein the maleimide-terminated polyimide is derived from a diamino compound selected from the group consisting of: 1,10-diaminodecane; 1,12-diaminododecane;
dimer diamine; 1,2-diamino-2-methylpropane; 1,2-diaminocyclohexane; 1,2-diaminopropane; 1,3-diaminopropane; 1,4-diaminobutane; 1,5-diaminopentane; 1,7-diaminoheptane; 1,8-diaminomenthane; 1,8-diaminooctane; 1,9-diaminononane; 3,3′-diamino-N-methyldipropylamine; diaminomaleonitrile; 1,3-diaminopentane; 9,10-diaminophenanthrene; 4,4′-diaminooctafluorobiphenyl; 3,5-diaminobenzoic acid; 3,7-diamino-2-methoxyfluorene; 4,4′-diaminobenzophenone; 3,4-diaminobenzophenone; 3,4-diaminotoluene; 2,6-diaminoanthroquinone; 2,6-diaminotoluene; 2,3-diaminotoluene; 1,8-diaminonaphthalene; 2,4-diaminotoluene; 2,5-diaminotoluene; 1,4-diaminoanthroquinone; 1,5-diaminoanthroquinone; 1,5-diaminonaphthalene; 1,2-diaminoanthroquinone; 2,4-cumenediamine; 1,3-bisaminomethylbenzene; 1,3-bisaminomethylcyclohexane; 2-chloro-1,4-diaminobenzene; 1,4-diamino-2,5-dichlorobenzne; 1,4-diamino-2,5-dimethylbenzene; 4,4′-diamino-2,2′-bistrifluoromethylbiphenyl; bis(amino-3-chlorophenyl)ethane; bis(4-amino-3,5-dimethylphenyl)methane; bis(4-amino-3,5-diethylphenyl)methane; bis(4-amino-3-ethyl diaminofluorene; diaminobenzoic acid; 2,3-diaminonaphthalene; 2,3-diaminophenol; -5-methylphenyl)methane; bis(4-amino-3-methylphenyl)methane; bis(4-amino-3-ethylphenyl)methane; 4,4′-diaminophenylsulfone; 3,3′-diaminophenylsulfone; 2,2-bis(4,-(4aminophenoxy)phenyl)sulfone; 2,2-bis(4-(3-aminophenoxy)phenyl)sulfone; 4,4′-oxydianiline; 4,4′-diaminodiphenyl sulfide; 3,4′-oxydianiline; 2,2-bis(4-(4-aminophenoxy)phenyl)propane; 1,3-bis(4-aminophenoxy)benzene; 4,4′-bis(4-aminophenoxy)biphenyl; 4,4′-diamino-3,3′-dihydroxybiphenyl; 4,4′-diamino-3,3′-dimethylbiphenyl; 4,4′-diamino-3,3′-dimethoxybiphenyl; Bisaniline M; Bisaniline P; 9,9-bis(4-aminophenyl)fluorene; o-tolidine sulfone; methylene bis(anthranilic acid); 1,3-bis(4-aminophenoxy)-2,2-dimethylpropane; 1,3-bis(4-aminophenoxy)propane; 1,4-bis(4-aminophenoxy)butane; 1,5-bis(4-aminophenoxy)butane; 2,3,5,6-tetramethyl-1,4-phenylenediamine; 3,3′,5,5′-tetramehylbenzidine; 4,4′-diaminobenzanilide; 2,2-bis(4-aminophenyl)hexafluoropropane; polyoxyalkylenediamines (e.g. Huntsman's Jeffamine D-230, D400, D-2000, and D-4000 products); 1,3-cyclohexanebis(methylamine); m-xylylenediamine; p-xylylenediamine; bis(4-amino-3-methylcyclohexyl)methane; and 1,2-bis(2-aminoethoxy)ethane; 3(4),8(9)-bis(aminomethyl)tricyclo(5.2.1.0^{2,6})decane.

55. The composition of claim 54, wherein the maleimide-terminated polyimide is derived by contacting the diamino compound with a dianhydride, followed by azeotropic distillation of water,
wherein the dianhydride comprises at least one dianhydride selected from the group consisting of: polybutadiene-graft-maleic anhydride; polyethylene-graft-maleic anhydride; polyethylene-alt-maleic anhydride; polymaleic anhydride-alt-1-octadecene; polypropylene-graft-maleic anhydride; poly(styrene-co-maleic anhydride); pyromellitic dianhydride; maleic anhydride, succinic anhydride; 1,2,3,4-cyclobutanetetracarboxylic dianhydride; 1,4,5,8-naphthalenetetracarboxylic dianhydride; 3,4,9,10-perylenentetracarboxylic dianhydride; bicyclo(2.2.2)oct-7-ene-2,3,5,6-tetracarboxylic dianhydride; diethylenetriaminepentaacetic dianhydride; ethylenediaminetetraacetic dianhydride; 3,3′,4,4′-benzophenone tetracarboxylic dianhydride; 3,3′,4,4′-biphenyl tetracarboxylic dianhydride; 4,4′-oxydiphthalic anhydride; 3,3′,4,4′-diphenylsulfone tetracarboxylic dianhydride; 2,2′-bis(3,4-dicarboxyphenyl)hexafluoropropane dianhydride; 4,4′-bisphenol A diphthalic anhydride; 5-(2,5-dioxytetrahydro)-3-methyl-3-cyclohexene-1,2-dicarboxylic anhydride; ethylene glycol bis(trimellitic anhydride); hydroquinone diphthalic anhydride; allyl nadic anhydride; 2-octen-1-ylsuccinic anhydride; phthalic anhydride; 1,2,3,6-tetrahydrophthalic anhydride; 3,4,5,6-tetrahydrophthalic anhydride; 1,8-naphthalic anhydride; glutaric anhydride; dodecenylsuccinic anhydride; hexadecenylsuccinic anhydride; hexahydrophthalic anhydride; methylhexahydrophthalic anhydride; tetradecenylsuccinic anhydride; 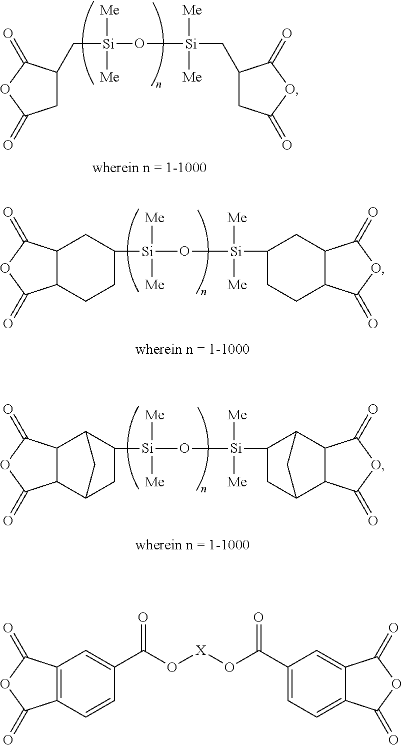
wherein X is a saturated or unsaturated straight or branched alkyl, polyester, polyamide, polyether, polysiloxane, or polyurethane,

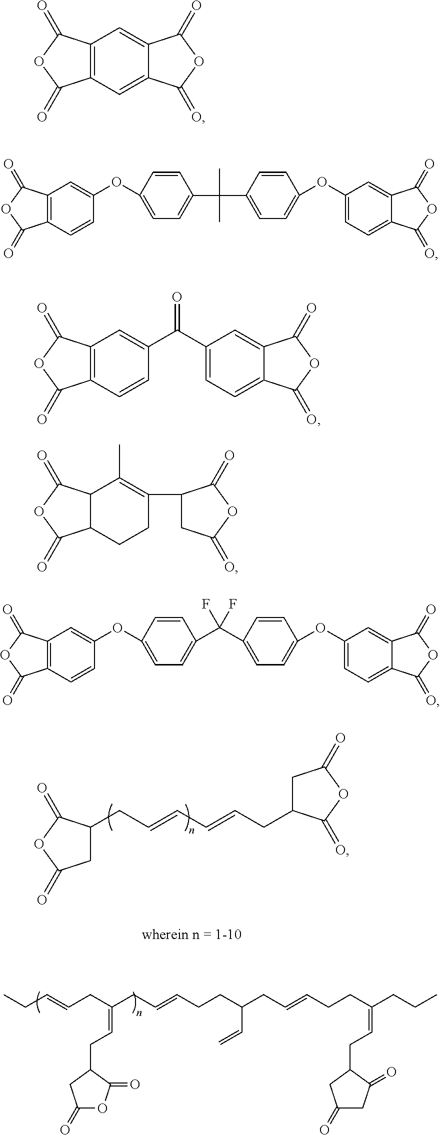

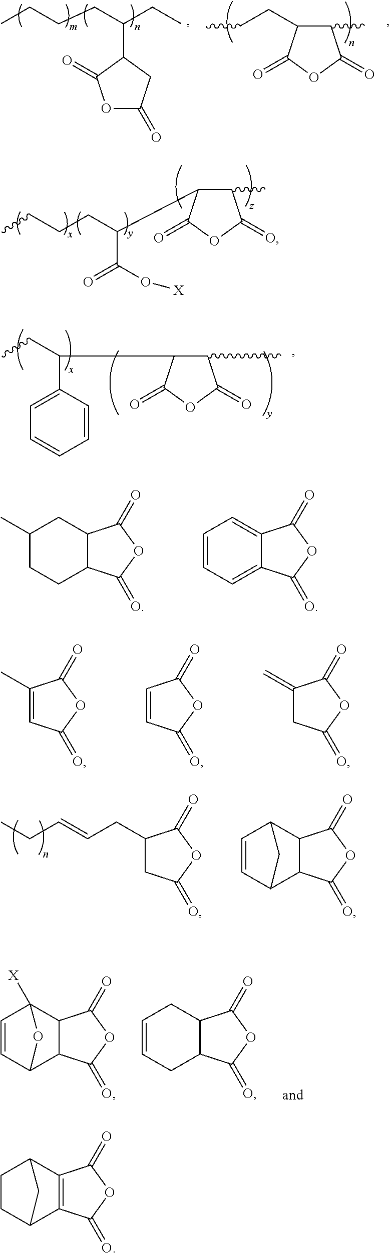

56. The composition of claim 53, wherein R is selected from the group her include alkyl, alkenyl, alkynyl, hydroxy, oxo, alkoxy, mercapto, cycloalkyl, substituted cycloalkyl, heterocyclic, substituted heterocyclic, aryl, substituted aryl, heteroaryl, substituted heteroaryl, aryloxy, substituted aryloxy, halogen, haloalkyl, cyano, nitro, nitrone, amino, amido, —C(O)H, —C(O), S, S(O)2-, —OC(O)—O—, —NR—C(O)—, —NR—C(O)—NR—, and —OC(O)—NR—.

57. The composition of claim 53, wherein R is H or lower alkyl, acyl, oxyacyl, carboxyl, carbamate, sulfonyl, sulfonamide, sulfuryl, and the like, and X is a polymerizable or curative moiety.

58. The composition of claim 53, wherein the filler is a perfluorinated hydrocarbon.

59. The composition of claim 59, wherein the perfluorinated hydrocarbon is a polytetrafluoroethylene, having the structural formula:

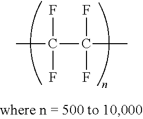

60. The composition of claim 53, wherein the filler is a Polyhedral Oligomeric Silsesquioxane (POSS) nanoparticle.

61. The composition of claim 60, wherein the POSS is selected from the group consisting of: an epoxy cyclohexyl POSS, an acrylo propyl POSS, an octylisobutyl POSS, an octadimethylsilane POSS, trisilanophenyl POSS, an aminopropyl isobutyl POSS, a glycidyl POSS, a dodecaphenyl POSS, an octatetramethyl ammonium POSS, a trisilanol isobutyl POSS, an N-phenyl aminopropyl POSS, a methacryl POSS, an isooctyl POSS, a polyethylene glycol POSS, a trisilanol isooctyl POSS, and combinations thereof.

62. The composition claim of claim 53, wherein the composition is selected from the group consisting of: a film, a coating, a die-attach paste, a die-attach film, a protective layer, a composite packaging, and a composite.

63. The composition of claim 62, wherein the composition is a film having a low dielectric constant and a low dissipation factor.

64. The film composition of claim 63, comprising 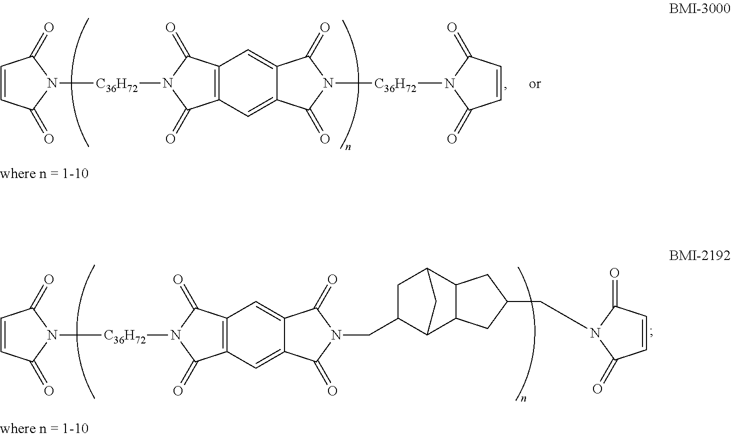
a POSS, Teflon or a functionalize polyethylene derivative; and
a curing initiator.

65. The composition of claim 62, wherein the composition is a microelectronics composition.

66. A coating of claim 62, wherein the coating is a conformal coating.

67. An article of manufacture constructed with the composition of claim 53, wherein the article of manufacture is selected from the group consisting of a fuel cell, a flexible copper clad laminate, a lithium-ion battery, a pipe lining, an aircraft and a marine craft.

68. The article of manufacture of claim 67, wherein the composition has a low dielectric constant and a low dissipation factor.

69. A curable composition comprising:
a) at least one low dielectric constant, low dissipation factor resin; and
b) at least one compound selected from the group consisting of: adhesion promoters, cure catalysts, inhibitors, fillers, fire retardants, and reactive diluents,
wherein the at least one low dielectric constant, low dissipation factor resin comprises a maleimide-terminated polyimide,
wherein the at least one low dielectric constant, low dissipation factor resin comprises:
i) a functionalized polyethylene compound having the structure of Formula VI: 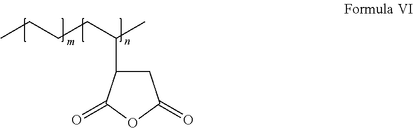
or
ii) a maleimide-terminated polyimide that is a functionalized polypropylene compound having the structure of Formula VII: 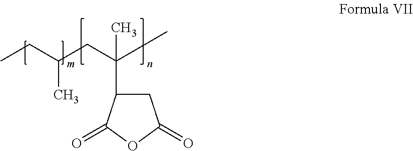
or
iii) at least one compound selected from Formulae X-XVI: 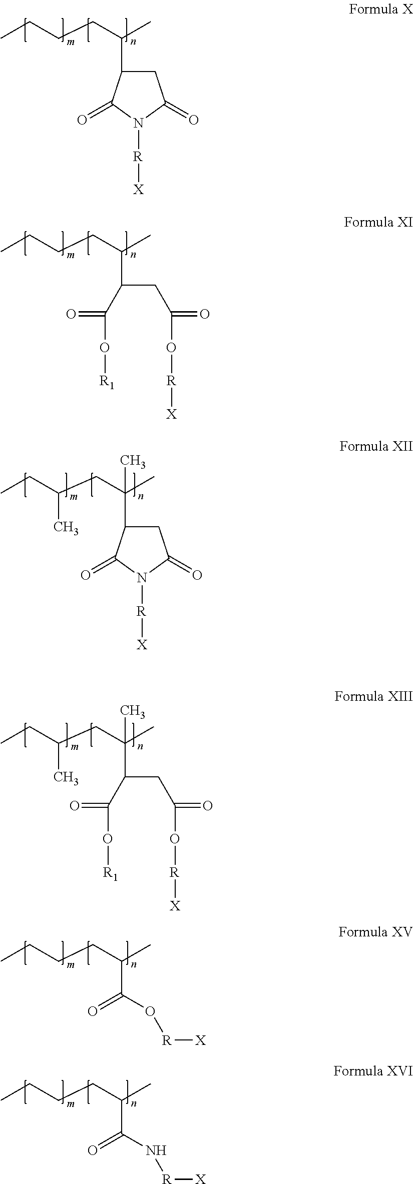
wherein, R₁ is H, methyl, alkyl, alkenyl, cycloalkenyl, cycloalkyl, heterocyclic, aryl, or heteroaryl, and
R is independently substituted or unsubstituted aliphatic, aromatic, heteroaromatic, siloxane, unsaturated hydrocarbon, polyester, polyamide, or polyurethane moieties
the value of m is an interger from 50-1000; and
the value of n is an interger from 1-10.

70. The composition of claim 69, wherein the functionalized polyethylene compound is and oxidized polyethylene compound.

71. The compound of claim 70, wherein the oxidized polyethylene compound has the structure of Formula VIII:

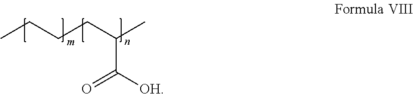

72. A curable composition comprising:
a) at least one low dielectric constant, low dissipation factor resin; and
b) at least one compound selected from the group consisting of: adhesion promoters, cure catalysts, inhibitors, fillers, fire retardants, and reactive diluents,
wherein the at least one low dielectric constant, low dissipation factor resin comprises an oligomer selected from the group consisting of: 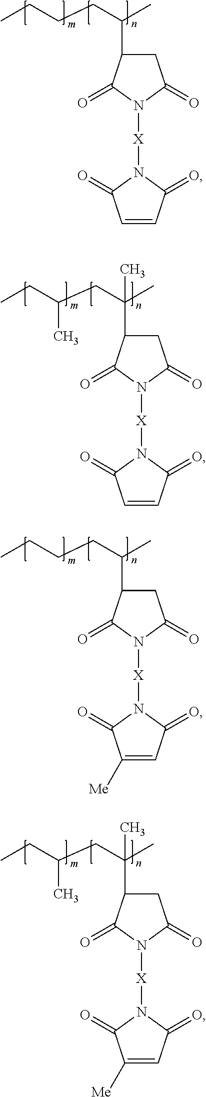 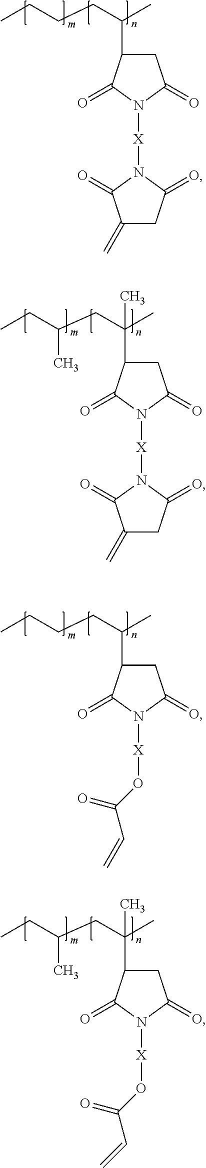 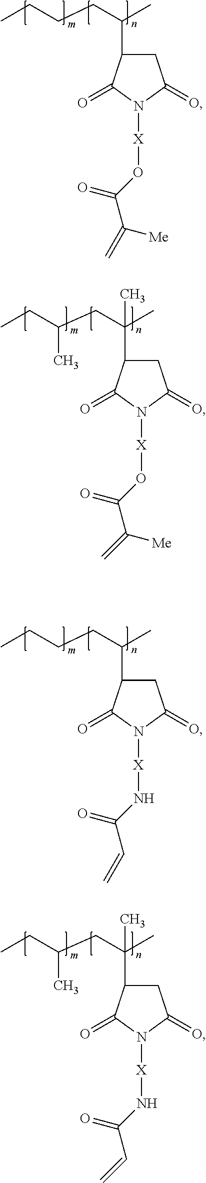 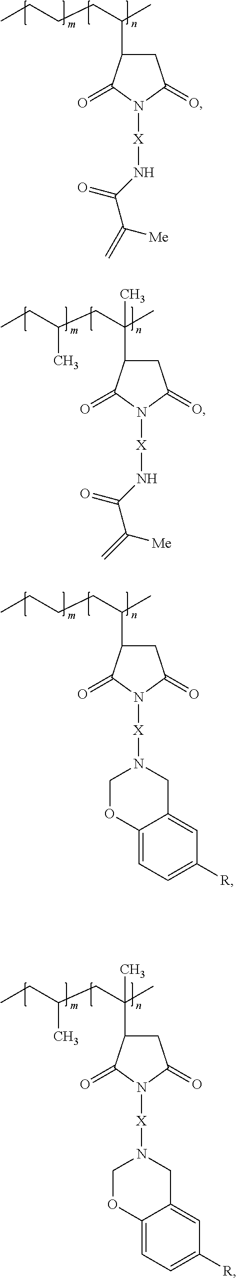 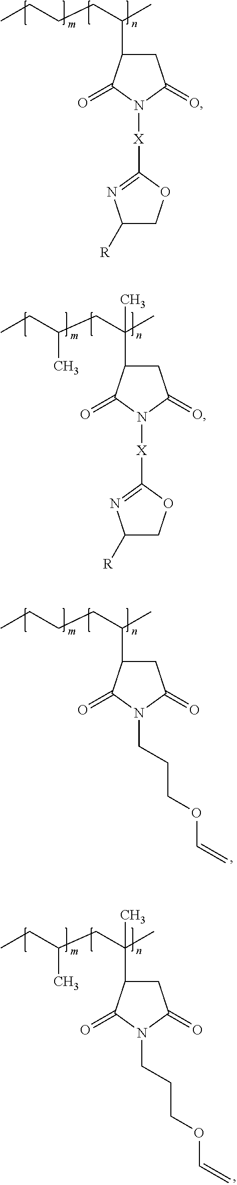 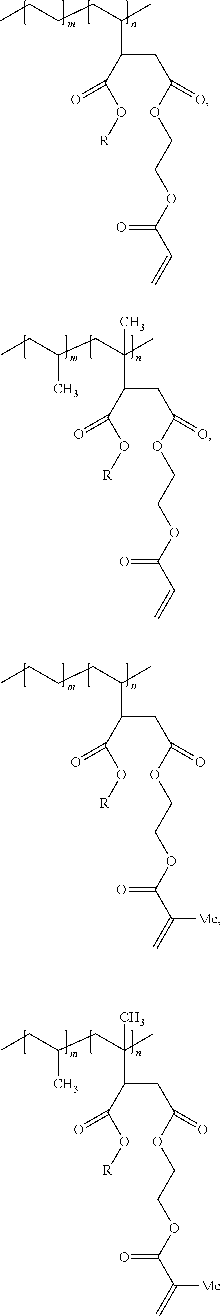 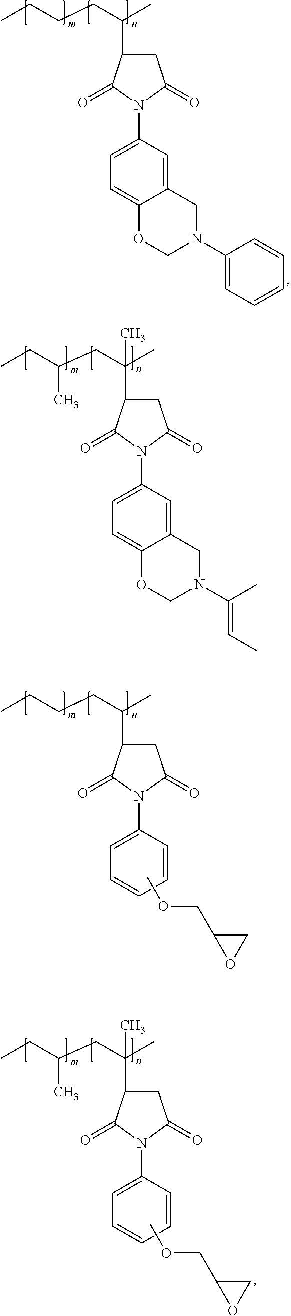 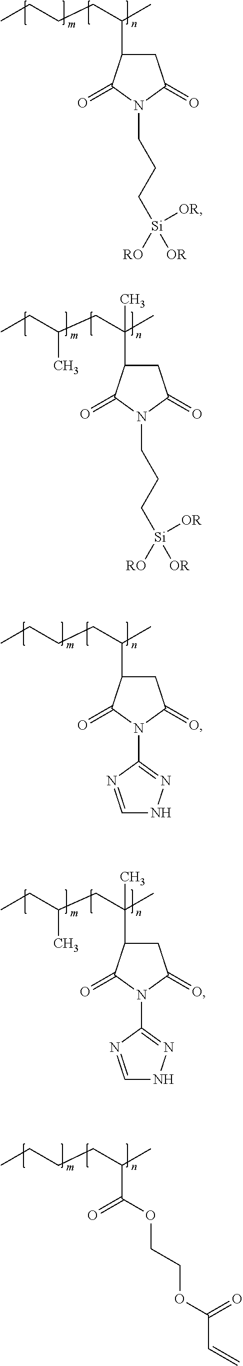 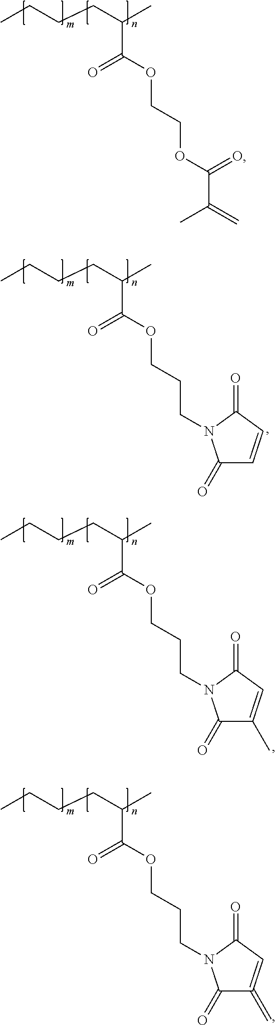 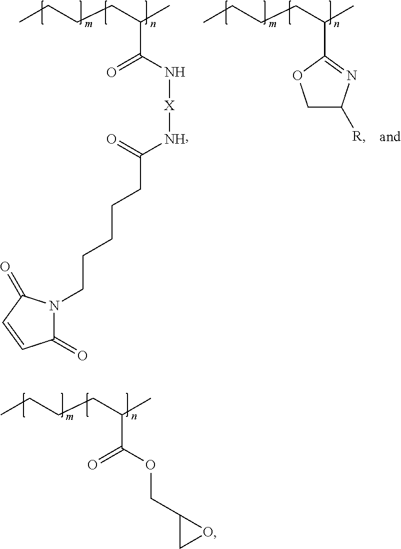
wherein
the value of m is an interger from 50-1000; and
the value of n is an interger from 1-10.
